(19) United States
(12) Patent Application Publication
(10) Pub. No.: US 2013/0077676 A1
(43) Pub. Date: Mar. 28, 2013

(54) IMAGE PROCESSING DEVICE AND METHOD

(71) Applicant: Kazushi Sato, Kanagawa (JP)

(72) Inventor: Kazushi Sato, Kanagawa (JP)

(21) Appl. No.: 13/701,649

(22) PCT Filed: Jun. 2, 2011
(86) PCT No.: PCT/JP2011/062649

§ 371 Date: Dec. 3, 2012

(30) Foreign Application Priority Data
Jun. 11, 2010 (JP) 2010-134037

(51) Int. Cl. H04N 7/26

(52) U.S. Cl. CPC H04N 7/26079
USPC 375/240.03

(57) ABSTRACT

The present disclosure relates to an image processing device and method capable of improving the coding efficiency. The image processing device includes: a correction unit that corrects the relation between a quantization parameter for a luminance component of image data and a quantization parameter for a chrominance component of the image data using an extended area offset value which is an offset value to be applied to a quantization process for an area that is larger than a predetermined size within an image of the image data; a quantization parameter generating unit that generates the quantization parameter for the chrominance component of the area that is larger than the predetermined size from the quantization parameter for the luminance component based on the relation corrected by the correction unit; and a quantization unit that quantizes the data of the area using the quantization parameter generated by the quantization parameter generation unit. The present disclosure can be applied to an image processing device, for example.

### TECHNICAL FIELD

The present disclosure relates to an image processing device and method, and more particularly, to an image processing device and method capable of suppressing deterioration in the image quality of a chrominance signal.

### BACKGROUND ART

In recent years, devices, which treat image information as digital data, which, in such a case, aim to transmit and store information with a high efficiency, and which adhere to a scheme, such as Moving Picture Experts Group (MPEG), for compressing image information using orthogonal transformation, such as discrete cosine transformation, and using motion compensation by utilizing redundancy that is unique to the image information have become widespread in both information distribution in broadcasting stations and information reception in ordinary homes.

In particular, MPEG2 (International Organization for Standardization (ISO)/International Electrotechnical Commission (IEC) 13818-2), which is defined as a general image encoding scheme, is a standard covering both interlaced scan images and progressive scan images, and standard resolution images and high-definition images, and is currently widely used in a wide variety of applications including professional applications and consumer applications. Using an MPEG2 compression scheme, for example, a coding rate (a bit rate) of 4 to 8 Mbps is assigned in a case of a standard-resolution interlaced scan image having 720×480 pixels, and a coding rate of 18 to 22 Mbps is assigned in a case of a high-resolution interlaced scan image having 1920×1088 pixels, whereby a high compression ratio and an excellent image quality can be realized.

MPEG2 was mainly intended for high-image-quality coding appropriate for broadcasting, but was not compatible with an encoding scheme for realizing a coding rate (a bit rate) lower than that determined in MPEG1, i.e., a higher compression ratio. It was considered that needs for such an encoding scheme will increase in the future as mobile terminals become widespread, and an MPEG4 encoding scheme was standardized for the increasing needs. Regarding an image encoding scheme, the specification of the scheme was approved as an ISO/IEC 14496-2 international standard in December, 1998.

Furthermore, in recent years, standardization of a standard called H.26L (International Telecommunication Union Telecommunication Standardization Sector (ITU-T) Q6/16 Video Coding Expert Group (VCEG)), which originally aimed to code pictures that are used for teleconferences, has been in progress. It is known that, although H.26L requires a larger amount of computation for coding and decoding the pictures, compared with a conventional encoding scheme such as MPEG2 or MPEG4, a higher coding efficiency is realized with H.26L. Additionally, currently, as part of MPEG4 activities, standardization for realizing a higher coding efficiency has been performed as Joint Model of Enhanced-Compression Video Coding on the basis of H.26L by incorporating functions that are not supported in H.26L.

Regarding a schedule of standardization, an international standard called H.264 and MPEG-4 Part 10 (Advanced Video Coding, hereinafter refer to as AVC) was set in March, 2003.

However, as in the related art, the use of 16×16 pixels as a macroblock size is not optimal for a large image frame such as with Ultra High Definition (UHD; 4000×2000 pixels) which is the subject of next-generation encoding schemes. Accordingly, Non-Patent Document 1 or the like proposes the use of 64×64 pixels or 32×32 pixels as the macroblock size.

That is, Non-Patent Document 1 employs a hierarchical structure and defines a larger block as a superset thereof while maintaining compatibility with the macroblocks of the present AVC encoding scheme with regard to blocks having a size of 16×16 pixels or less.

### CITATION LIST

### Non-Patent Document

Non-Patent Document 1: Peisong Chenn, Yan Ye, Marta Karczewicz, “Video Coding Using Extended Block Sizes”, COM16-C123-E, Qualcomm Inc, January 2009

### SUMMARY OF THE INVENTION

### Problems to be Solved by the Invention

However, in the case of a chrominance signal, motion information obtained for a luminance signal is scaled and used as the motion information for the chrominance signal. Thus, there is a possibility that the obtained motion information is not appropriate for the chrominance signal. In particular, when a block size is extended as proposed in Non-Patent Document 1, an error is likely to occur in the motion information due to the size of the area. Moreover, in the case of a chrominance signal, since the error in the motion information appears as blurring of colors in an image, the error is easily visible. The large area becomes the cause which makes the blurring phenomenon of the colors easily visible. As above, the influence on visibility, of the error in the motion information in an extended macroblock of the chrominance signal may increase.

The present disclosure has been made in view of the above problems, and an object thereof is to provide a technique capable of controlling a quantization parameter for an extended area of a chrominance signal independently from the quantization parameter of the other portions and suppressing deterioration in the image quality of the chrominance signal while suppressing an increase of the coding rate.

### Solution to Problems

An aspect of the present disclosure is an image processing device including: a correction unit that corrects the relation between a quantization parameter for a luminance component of image data and a quantization parameter for a chrominance component of the image data using an extended area offset value which is an offset value to be applied to a quantization process of an area that is larger than a predetermined size within an image of the image data; a quantization parameter generating unit that generates the quantization parameter for the chrominance component of the area that is larger than the predetermined size from the quantization parameter for the luminance component based on the relation corrected by the correction unit; and a quantization unit that quantizes the data of the area using the quantization parameter generated by the quantization parameter generation unit.

The extended area offset value may be a parameter different from a normal area offset value which is an offset value applied to a quantization process for the chrominance component, and the correction unit may correct the relation with respect to the quantization process for the chrominance component of the area having the predetermined size or smaller using the normal area offset value.

The image processing device may further include: a setting unit that sets the extended area offset value.

The setting unit may set the extended area offset value to be equal to or greater than the normal area offset value.

The setting unit may set the extended area offset value for each of a Cb component and a Cr component of the chrominance component, and the quantization parameter generating unit may generate the quantization parameters for the Cb component and the Cr component using the extended area offset values set by the setting unit.

The setting unit may set the extended area offset value according to a variance value of the pixel values of the luminance component and the chrominance component in respective predetermined areas within the image.

The setting unit may set the extended area offset value based on an average value of the variance values of the pixel values of the chrominance component on the entire screen with respect to an area in which the variance value of the pixel values of the luminance component in the respective areas is equal to or smaller than a predetermined threshold value.

The image processing device may further include: an output unit that outputs the extended area offset value.

The output unit may inhibit outputting of the extended area offset value that is greater than the normal area offset value.

The extended area offset value may be applied to the quantization process for an area having a size larger than 16×16 pixels, and the normal area offset value may be applied to the quantization process for an area having a size equal to or smaller than 16×16 pixels.

An aspect of the present disclosure is an image processing method of an image processing device, including: allowing a correction unit to correct the relation between a quantization parameter for a luminance component of image data and a quantization parameter for a chrominance component of the image data using an extended area offset value which is an offset value to be applied to a quantization process for an area that is larger than a predetermined size within an image of the image data; allowing a quantization parameter generating unit to generate the quantization parameter for the chrominance component of the area that is larger than the predetermined size from the quantization parameter for the luminance component based on the corrected relation; and allowing a quantization unit to quantize the data of the area using the generated quantization parameter.

Another aspect of the present disclosure is an image processing device including a correction unit that corrects the relation between a quantization parameter for a luminance component of image data and a quantization parameter for a chrominance component of the image data using an extended area offset value which is an offset value to be applied to a quantization process of an area that is larger than a predetermined size within an image of the image data; a quantization parameter generating unit that generates the quantization parameter for the chrominance component of the area that is larger than the predetermined size from the quantization parameter for the luminance component based on the relation corrected by the correction unit; and a dequantization unit that dequantizes the data of the area using the quantization parameter generated by the quantization parameter generating unit.

Another aspect of the present disclosure is an image processing method of an image processing device, including: allowing a correction unit to correct the relation between a quantization parameter for a luminance component of image data and a quantization parameter for a chrominance component of the image data using an extended area offset value which is an offset value to be applied to a quantization process of an area that is larger than a predetermined size within an image of the image data; allowing a quantization parameter generating unit to generate the quantization parameter for the chrominance component of the area that is larger than the predetermined size from the quantization parameter for the luminance component based on the corrected relation; and allowing a dequantization unit to dequantize the data of the area using the generated quantization parameter.

According to an embodiment of the present disclosure, the relation between a quantization parameter for a luminance component of image data and a quantization parameter for a chrominance component of the image data is corrected using an extended area offset value which is an offset value to be applied to a quantization process for an area that is larger than a predetermined size within an image of the image data. The quantization parameter for the chrominance component of the area that is larger than the predetermined size from the quantization parameter for the luminance component is generated based on the corrected relation. The data of the area is quantized using the generated quantization parameter.

According to another embodiment of the present disclosure, the relation between a quantization parameter for a luminance component of image data and a quantization parameter for a chrominance component of the image data is corrected using an extended area offset value which is an offset value to be applied to only a quantization process for an area that is larger than a predetermined size within an image of the image data. The quantization parameter for the chrominance component of the area that is larger than the predetermined size from the quantization parameter for the luminance component is generated based on the corrected relation. The data of the area is dequantized using the generated quantization parameter.

### Effects of the Invention

According to the present disclosure, it is possible to process an image. In particular, it is possible to improve coding efficiency.

### BRIEF DESCRIPTION OF DRAWINGS

FIG. 1 is a diagram for explaining a ¼-pixel accuracy motion prediction and compensation process defined in the AVC encoding scheme.

FIG. 2 is a diagram for explaining a motion prediction and compensation scheme for a chrominance signal determined in the AVC encoding scheme.

FIG. 3 is a diagram illustrating an example of a macroblock.

FIG. 4 is a diagram for explaining an encoding process of motion vector information defined in the AVC encoding scheme.

FIG. 5 is a diagram for explaining a multi-reference frame defined in the AVC encoding scheme.

FIG. 6 is a diagram for explaining a temporal direct mode defined in the AVC encoding scheme.

FIG. 7 is a diagram for explaining another example of a macroblock.

FIG. 8 is a diagram illustrating the relation between the quantization parameters of a luminance signal and a chrominance signal determined in the AVC encoding scheme.

FIG. 9 is a block diagram illustrating a main configuration example of an image encoding device.

FIG. 10 is a block diagram illustrating a detailed configuration example of a quantization unit 105 of FIG. 9.

FIG. 11 is a flowchart for explaining an example of the flow of an encoding process.

FIG. 12 is a flowchart for explaining an example of the flow of a quantization process.

FIG. 13 is a flowchart for explaining an example of the flow of an offset information calculating process.

FIG. 14 is a block diagram illustrating a main configuration example of an image decoding device.

FIG. 15 is a block diagram illustrating a detailed configuration example of a dequantization unit of FIG. 14.

FIG. 16 is a flowchart for explaining an example of the flow of a decoding process.

FIG. 17 is a flowchart for explaining an example of the flow of a dequantization process.

FIG. 18 is a block diagram illustrating a main configuration example of a personal computer.

FIG. 19 is a block diagram illustrating a main configuration example of a television receiver.

FIG. 20 is a block diagram illustrating a main configuration example of a cellular phone.

FIG. 21 is a block diagram illustrating a main configuration example of a hard disk recorder.

FIG. 22 is a block diagram illustrating a main configuration example of a camera.

### MODE FOR CARRYING OUT THE INVENTION

Hereinafter, modes (hereinafter referred to as embodiments) for carrying out the present technology will be described. The description will be given in the following order:

1. First embodiment (Image encoding device)

2. Second embodiment (Image decoding device)

3. Third embodiment (Personal computer)

4. Fourth embodiment (Television receiver)

5. Fifth embodiment (Cellular phone)

Sixth embodiment (Hard disk recorder)

7. Seventh embodiment (Camera)

### 1. First Embodiment

### [Motion Prediction and Compensation Process]

In an encoding scheme such as the MPEG-2 scheme or the like, a motion prediction and compensation process with ½-pixel accuracy is performed by a linear interpolation process. However, in the AVC encoding scheme, a motion prediction and compensation process with ¼-pixel accuracy is performed using a 6-tap FIR filter. In this way, the coding efficiency is improved.

For example, in FIG. 2, the position A indicates the position with integer-pixel accuracy stored in a frame memory, the positions b, c, and d indicate the positions with ½-pixel accuracy, and the positions e1, e2, and e3 indicate the positions with ¼-pixel accuracy.

Here, the function Clip1 ( ) is defined as in the following expression (1).

$$\begin{matrix}[ Mathematical formula 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

In the expression (1), when the input image has 6-bit accuracy, the value of max_pix is 255.

The pixel values at the positions b and d are generated according to the following expressions (2) and (3) using a 6-tap FIR filter.

[Mathematical formula 2]

F=A₋₂−5·A₋₁+20·A₀+20·A₁−5·A₂+A₃ (2)

[Mathematical formula 3]

b,d=Clip1((F+16)>>5) (3)

The pixel value at the position c is generated according to the following expressions (4) to (6) by applying a 6-tap FIR filter in the horizontal direction and the vertical direction.

[Mathematical formula 4]

F=b₋₂−5·b₋₁+20·b₀+20·b₁−5·b₂+b₃ (4)

or,

[Mathematical formula 5]

F=d₋₂−5·d₋₁+20·d₀+20·d₁−5·d₂+d₃ (5)

[Mathematical formula 6]

c=Clip1((F+512)>>10) (6)

The Clip process is performed just once at the end after a product-sum process is performed in both the horizontal direction and vertical direction.

The pixel values at the positions e1 to e3 are generated according to the following expressions (7) to (9) by linear interpolation.

[Mathematical formula 7]

e₁=(A+b+1)>>1 (7)

[Mathematical formula 8]

e₂=(b+d+1)>>1 (8)

[Mathematical formula 9]

e₃=(b+c+1)>>1 (9)

In the AVC encoding scheme, a motion prediction and compensation process for a chrominance signal is performed as illustrated in FIG. 2. That is ¼-pixel accuracy motion vector information for a luminance signal is converted to the motion vector information for a chrominance signal and thus has ⅛-pixel accuracy motion vector information. The ⅛-pixel accuracy motion prediction and compensation process is realized by linear interpolation. That is, in the example of FIG. 2, a motion vector v is calculated according to the following expression (10)

$$\begin{matrix} [ Mathematical formula 10 ] & \\ v = \frac{\begin{matrix}( s - {d}^{x} ) \cdot ( s - {d}^{y} ) \cdot A + {d}^{x} \cdot ( s - {d}^{y} ) \cdot B + ( s - {d}^{x} ) \cdot {d}^{y} \cdot C + \\ {d}^{x} \cdot {d}^{y} \cdot D\end{matrix}}{{s}^{2}} & ( 10 )\end{matrix}$$

### [Macroblock]

Moreover, in the MPEG-2 scheme, the motion prediction and compensation process is performed for 16×16 pixels in a case of a frame motion compensation mode, and the motion prediction and compensation process is performed for respective 16×8 pixels in each of a first field and a second field in a case of a field motion compensation mode.

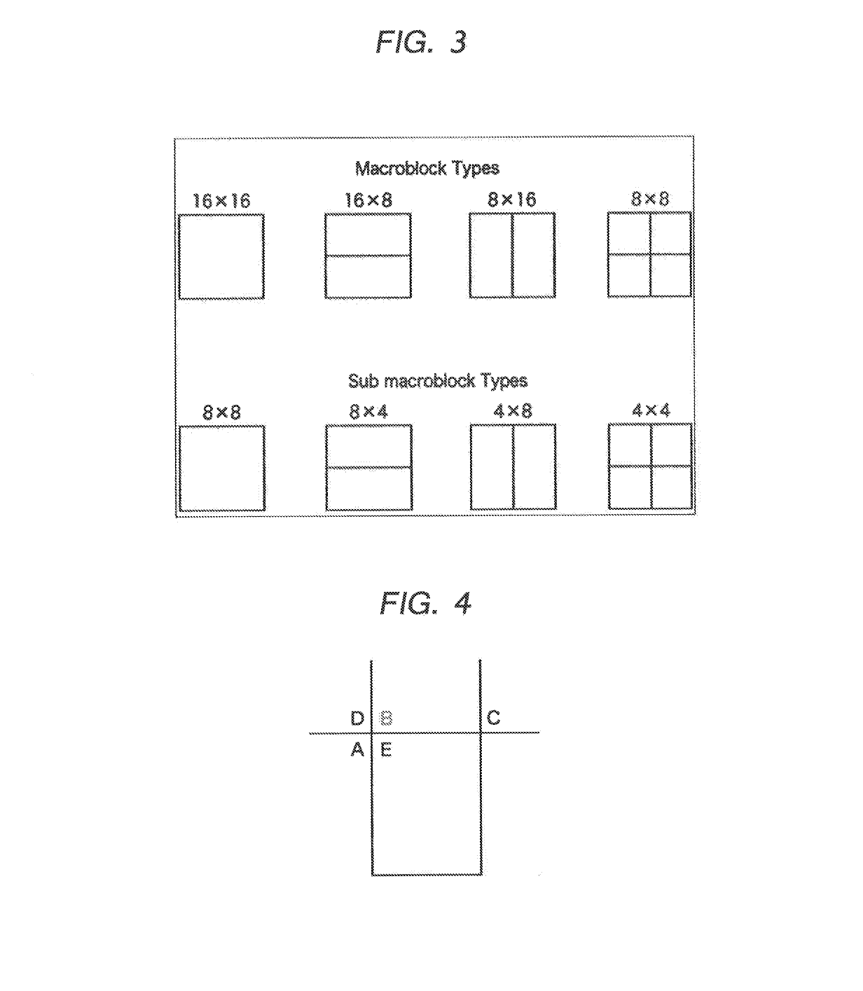

In contrast, in the AVC encoding scheme, as illustrated in FIG. 3, one macroblock made up of 16×16 pixels can be divided into partitions of any one of 16×16 pixels, 16×8 pixels, 6×16 pixels, or 8×8 pixels, and the respective partitions can have independent motion vector information. Further, the partition of 8×8 pixels can be divided into subpartitions of any one of 8×8 pixels, 8×4 pixels, 4×8 pixels, or 4×4 pixels as illustrated in FIG. 3, the respective subpartitions can have independent motion vector information.

### [Median Operation]

In the AVC encoding scheme, a large volume of motion vector information is generated when such a motion prediction and compensation process is performed. Thus, if the motion vector information is encoded as it is, the coding efficiency may deteriorate.

As a method of solving such a problem, in the AVC encoding scheme, the amount of the motion vector coding information is reduced by the following method.

FIG. 4 illustrates the motion compensation block E that is to be encoded now, and motion compensation blocks A to D that has been encoded and is adjacent to the motion compensation block E.

The motion vector information for X (X=A, B, C, D, E) is represented by mvₓ.

First, the prediction motion vector information pmv_{E} for the motion compensation block E is generated according to the following expression (11) by a median operation using the motion vector information for the motion compensation blocks A, B, and C.

[Mathematical formula 11]

pmv_{E}=med(mv_{A},mv_{B},mv_{C}) (11)

When the motion vector information for the motion compensation block C is “unavailable” due to the fact that the motion compensation block C is at the edge of an image frame, the motion vector information for the motion compensation block D is used instead.

Data mvd_{E} which is encoded in image compression information as the motion vector information for the motion compensation block E is generated according to the following expression (12) using pmv_{E}.

[Mathematical formula 12]

mvd_{E}=mv_{E}−pmv_{E} (12)

In actual processing, the process is performed independently with respect to each of the components in the horizontal direction and the vertical direction of the motion vector information.

### [Multi-Reference Frame]

Moreover, in the AVC encoding scheme, a multi-reference frame which is not defined in the conventional image information encoding scheme such as the MPEG-2 scheme or the H.263 scheme is defined.

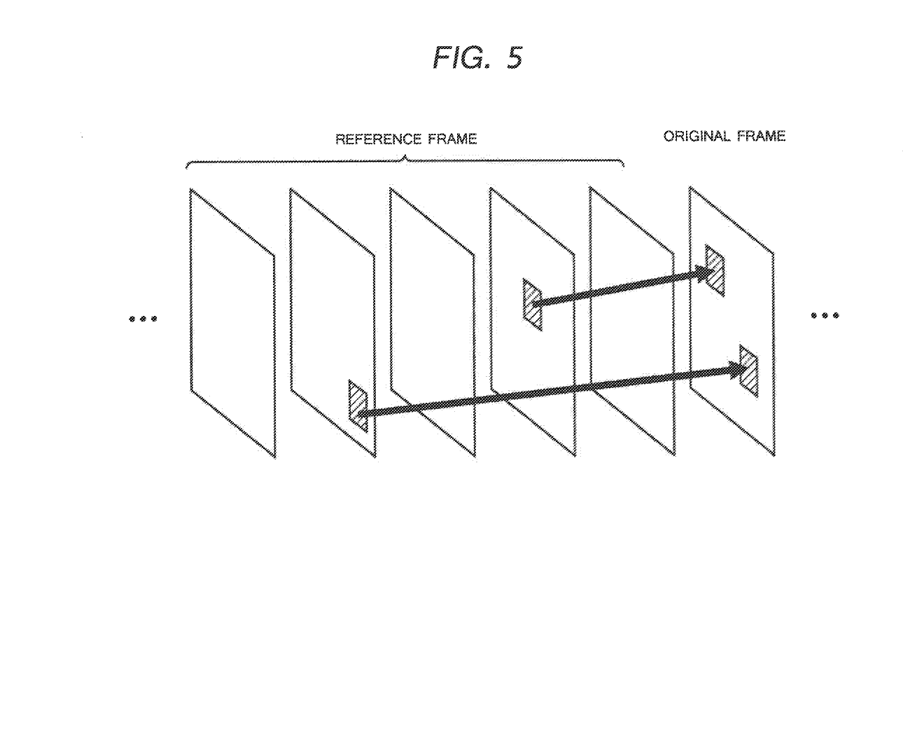

The multi-reference frame defined in the AVC encoding scheme will be explained with reference to FIG. 5. That is, in the MPEG-2 scheme or the H.263 scheme, in the case of P-pictures, the motion prediction and compensation process is performed by referencing only one reference frame that is stored in a frame memory. However, in the AVC encoding scheme, as illustrated in FIG. 5, a plurality of reference frames are stored in memories, and different memories can be referenced for each block.

However, although the volume of the motion vector information of B-pictures is significantly large, a mode called a direct mode is provided in the AVC encoding scheme.

That is, in the direct mode, the motion vector information is not stored in encoded data. A decoding device extracts the motion vector information of the block from the motion vector information of a neighboring or co-located block.

The direct mode includes two modes which are a spatial direct mode and a temporal direct mode. These modes can be switched for each slice.

In the spatial direct mode, the motion vector information mv_{E} of the motion compensation block E is defined according to the following expression (13).

mv_{E}=pmv_{E} (13)

That is, the motion vector information generated by median prediction is applied to the block.

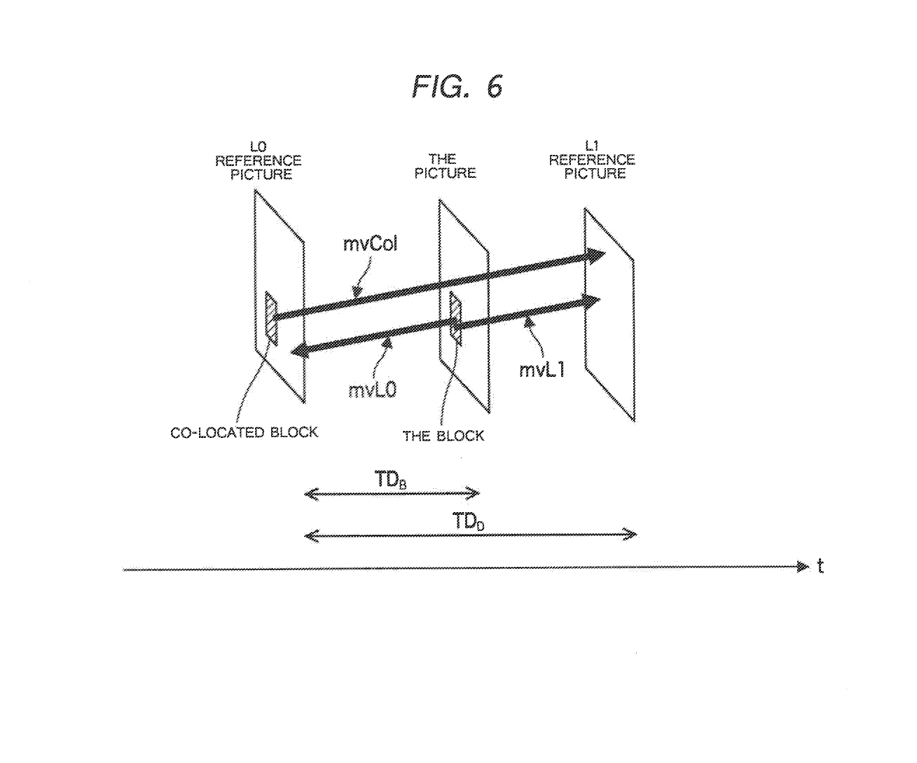

Next, the temporal direct mode will be explained with reference to FIG. 6.

In FIG. 6, a block at the same spatial address as the block in an L0-reference picture is defined as a co-located block, and the motion vector information of the co-located block is defined as mv_{col}. Moreover, the distance on the time axis between the picture and the L0-reference picture is defined as TD_{B}, and the distance on the time axis between the L0-reference picture and the L1-reference picture is defined as TD_{D}.

In this case, the motion vector information of the L0 and L1-reference pictures in the picture is calculated according to the following expressions (14) and (15).

$$\begin{matrix}[ Mathematical formula 13 ] & \\ {mv}_{L 0} = \frac{{TD}_{B}}{{TD}_{D}} {mv}_{col} & ( 14 ) \\ [ Mathematical formula 14 ] & \\ {mv}_{L 1} = \frac{{TD}_{D} - {TD}_{B}}{{TD}_{D}} {mv}_{col} & ( 15 )\end{matrix}$$

In the encoded data which is encoded according to the AVC encoding scheme, since the information TD that indicates the distance on the time axis is not present, the above operation is performed using a picture order count (POC).

Moreover, in the encoded data which is encoded according to the AVC encoding scheme, the direct mode can be defined in respective macroblocks of 16×16 pixels or blocks of 8×8 pixels.

### [Prediction Mode Selection]

However, in order to achieve higher coding efficiency in the AVC encoding scheme, it is important to select an appropriate prediction mode.

As an example of the selection method, a method which is implemented in the reference software (called a joint model (JM)) of H.264/MPEG-4/AVC (which is available at http://iphome.hhi.de/suehring/tml/index.htm) can be used.

The JM software enables a mode decision method to be selected from two modes of high complexity mode and low complexity mode which are described below. In any modes, a cost function value for each of the prediction modes Mode is calculated, and a prediction mode which minimizes the cost function value is selected as an optimal mode for the block or macroblock.

The cost function of the high complexity mode is calculated according to the following expression (16)

Cost(ModeεΩ)−D+λ*R (16)

Here, “Ω” is a total set of candidate modes for encoding the block or macroblock, and “D” is difference energy between a decoded image and an input image when encoded in the prediction mode Mode. Moreover, “λ” is the Lagrange's undetermined multiplier which is given as the function of a quantization parameter.

Further, “R” is a total coding rate when encoded in the mode Mode, including an orthogonal transform coefficient.

That is, when encoding is performed in the high complexity mode, it is necessary to perform a temporary encoding process according to all candidate modes Mode in order to calculate the parameters D and R, which incurs a larger computation amount.

The cost function of the low complexity mode is calculated according to the following expression (17).

Cost(ModeεΩ)=D+QP2Quant(QP)*HeaderBit (17)

Here, “D” is difference energy between a prediction image and an input image unlike the high complexity mode. Moreover, “QP2Quant (QP) is given as the function of a quantization parameter QP, and “HeaderBit” is a coding rate of information which belongs to header information (Header), which is called a motion vector or a mode, and which does not include an orthogonal transform coefficient.

That is, in the low complexity mode, although it necessary to perform a prediction process for the respective candidate modes Mode, since it is not necessary to obtain a decoded image, it is not necessary to perform the encoding process. Thus, the low complexity mode can be realized with a computation amount lower than that of the high complexity mode.

### [Extended Macroblock]

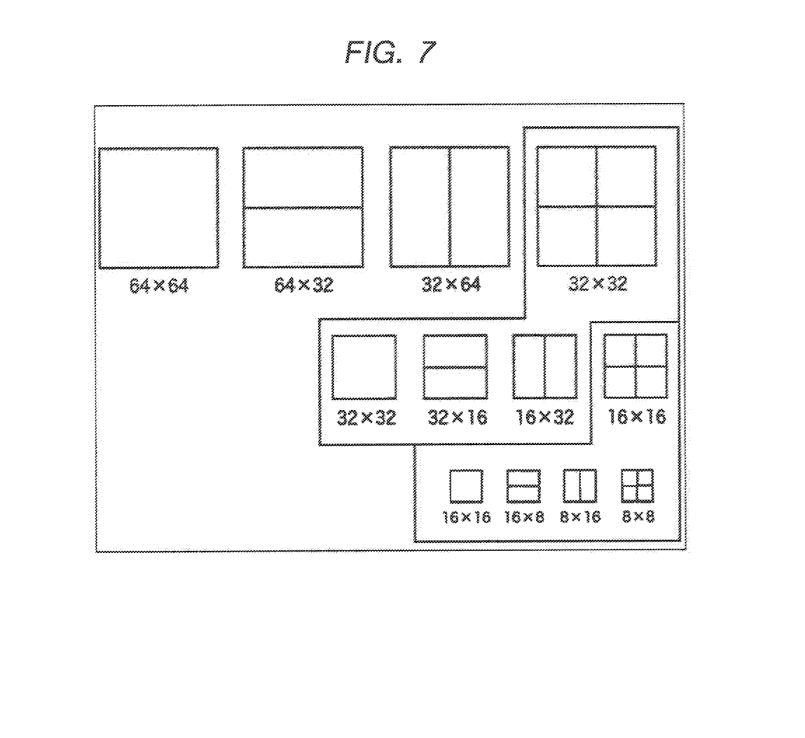

However, the use of 16×16 pixels as a macroblock size is not optimal for a large image frame such as with Ultra High Definition (UHD; 4000×2000 pixels) which is the subject of next-generation encoding schemes. Accordingly, as illustrated in FIG. 7, Non-Patent Document 1 or the like proposes the use (extended macroblocks) of 64×64 pixels or 32×32 pixels as the macroblock size.

That is, Non-Patent Document 1 employs a hierarchical structure as illustrated in FIG. 7 and defines a larger block as a superset thereof while maintaining compatibility with the macroblocks of the present AVC encoding scheme with regard to blocks having a size of 16×16 pixels or less.

In the following description, amacroblock that is larger than the block size (16×16 pixels) defined in the AVC encoding scheme will be referred to as an extended macro block. Moreover, a macroblock having a size equal to or greater than the block size (16×16 pixels) defined in the AVC encoding scheme will be referred to as normal macroblock.

The motion prediction and compensation process is performed in respective macroblocks which are the units of the encoding process or in respective sub-macroblocks that are obtained by dividing the macroblock into multiple areas. In the following description, the units of the motion prediction and compensation process will be referred to as a motion compensation partition.

In the case of an encoding scheme in which an extended macroblock that is larger than the block size (16×16 pixels) defined in the AVC encoding scheme, as illustrated in FIG. 7 is employed, there is a possibility that the motion compensation partition is also extended (larger than 16×16 pixels).

Moreover, in the case of an encoding scheme which uses the extended macroblock as illustrated in FIG. 7, as the motion information for the chrominance signal, information obtained in the luminance signal is scaled and used.

Thus, there is a possibility that the motion information is not appropriate for the chrominance signal.

In general, the size of a motion compensation partition when the motion prediction and compensation process is performed for an extended macroblock is larger than that of a normal macroblock. Thus, an error is likely to occur in the motion information, and it is highly likely that appropriate motion information is not obtained. Further, if the motion information for the chrominance signal is not appropriate, the error may appear as blurring of colors, which may have a great influence on vision. In particular, in the case of the extended macroblock, since the area is large, the blurring of colors may become more visible. As above, the image quality deterioration due to the motion prediction and compensation process for the extended macroblock of the chrominance signal may be more visible.

Therefore, a technique of increasing the amount of bits allocated during the quantization process to suppress image quality deterioration has been considered.

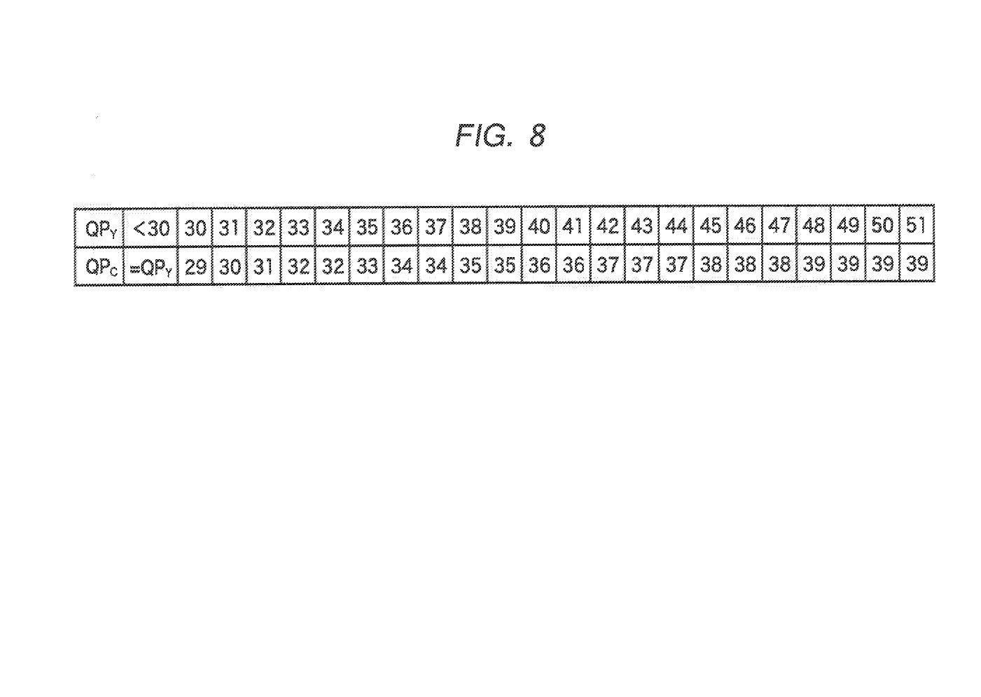

However, for example, in the AVC encoding scheme, as illustrated in FIG. 8, the relation in the initial state of a quantization parameter QP_{Y} for the luminance signal and a quantization parameter QP_{C} for the chrominance signal is determined in advance.

With regard to the relation in the initial state of the quantization parameters, the user adjusts the bit amount by shifting the relation illustrated in the table of FIG. 8 to the right or the left using chrominance_qp_index_offset which is an offset parameter that designates an offset value of the quantization parameter for the chrominance signal and which is included in a picture parameter set. For example, the user can prevent deterioration by allocating more bits to the chrominance signal than the initial value or allow a little deterioration to reduce the number of bits allocated to the chrominance signal.

However, in this offset parameter, since the bits of all chrominance signals are changed uniformly, the amount of allocated bits may change unnecessarily.

For example, as described above, the influence on the vision due to the error of the motion information is highly likely to appear strongly in a portion of the chrominance signal where the extended macroblock is employed. Thus, in order to suppress image quality deterioration in that portion, the amount of bits allocated to that portion only may be increased. However, if chrominance_qp_index_offset is changed, the bit amount may change in all portions of the chrominance signal. That is, the bit amount may increase in a small macroblock portion where the visual influence is relatively small. As a result, the coding efficiency may decrease unnecessarily.

Therefore, in the present disclosure, a dedicated offset parameter for an extended motion compensation partition of the chrominance signal is provided.

### [Image Encoding Device]

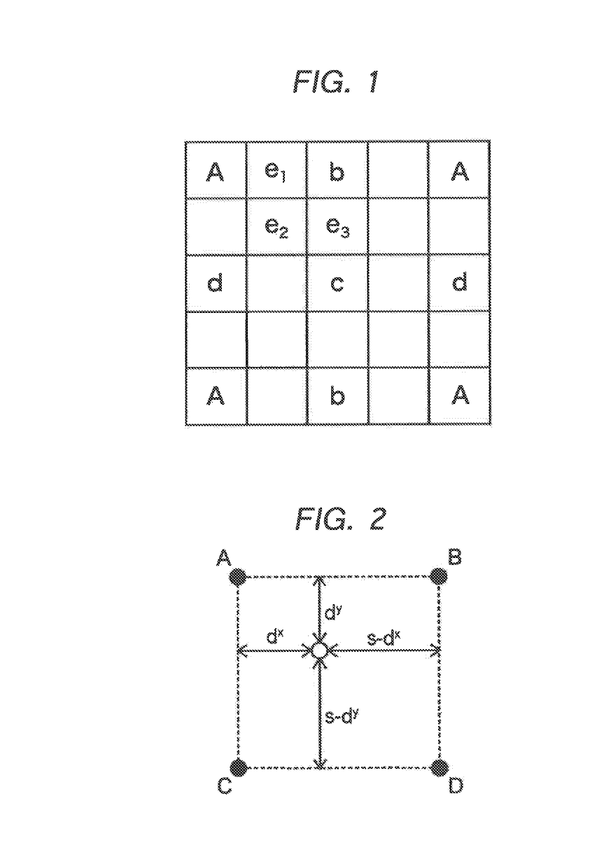

FIG. 1 illustrates the configuration of an embodiment of an image encoding device as an image processing device.

An image encoding device 100 illustrated in FIG. 1 is an encoding device that encodes an image according to the same scheme as the H.264 scheme and the Moving Picture Experts Group (MPEG)-4 Part10 (Advanced Video Coding (AVC)) (hereinafter referred to as H.264/AVC).

It should be noted that the image encoding device 100 performs an appropriate quantization process so that the influence on the vision due to an error of the motion information is suppressed in the quantization process.

In the example of FIG. 1, the image encoding device 100 includes an analog/digital (A/D) conversion unit 101, a frame rearrangement buffer 102, a computing unit 103, an orthogonal transform unit 104, a quantization unit 105, a lossless encoding unit 106, and a storage buffer 107. Moreover, the image encoding device 100 includes a dequantization unit 108, an inverse orthogonal transform unit 109, a computing unit 110, a deblocking filter 111, a frame memory 112, a selecting unit 113, an intra-prediction unit 114, a motion prediction and compensation unit 115, a selecting unit 116, and a rate control unit 117.

The image encoding device 100 further includes an extended macroblock chrominance quantization unit 121 and an extended macroblock chrominance dequantization unit 122.

The A/D conversion unit 101 performs A/D conversion on input image data and outputs the digital image data to the frame rearrangement buffer 102 which stores the digital image data.

The frame rearrangement buffer 102 rearranges the frames of the image arranged in the stored order for display according to a group of picture (GOP) structure so that the frames of the image are arranged in the order for encoding. The frame rearrangement buffer 102 supplies the image in which the frames are rearranged to the computing unit 103. Moreover, the frame rearrangement buffer 102 also supplies the image in which the frames are rearranged to the intra-prediction unit 114 and the motion prediction and compensation unit 115.

The computing unit 103 subtracts a prediction image supplied from the intra-prediction unit 114 or the motion prediction and compensation unit 115 via the selecting unit 116 from the image read from the frame rearrangement buffer 102 to obtain difference information thereof and outputs the difference information to the orthogonal transform unit 104.

For example, in the case of an image which is subjected to intra-coding, the computing unit 103 subtracts the prediction image supplied from the intra-prediction unit 114 from the image read from the frame rearrangement buffer 102. Moreover, for example, in the case of an image which is subject to inter-coding, the computing unit 103 subtracts the prediction image supplied from the motion prediction and compensation unit 115 from the image read from the frame rearrangement buffer 102.

The orthogonal transform unit 104 performs orthogonal transform such as discrete cosine transform or Karhunen-Loeve transform with respect to the difference information supplied from the computing unit 103 and supplies a transform coefficient thereof to the quantization unit 105.

The quantization unit 105 quantizes the transform coefficient output from the orthogonal transform unit 104. The quantization unit 105 sets a quantization parameter based on the information supplied from the rate control unit 117 and performs quantization.

It should be noted that quantization of the extended macroblock of a chrominance signal is performed by the extended macroblock chrominance quantization unit 121. The quantization unit 105 supplies offset information and an orthogonal transform coefficient for the extended macroblock of the chrominance signal to the extended macroblock chrominance quantization unit 121 which then performs quantization, and the quantization unit 105 acquires a quantized orthogonal transform coefficient.

The quantization unit 105 supplies a quantized transform coefficient, which is generated by the quantization unit 105 or generated by the extended macroblock chrominance quantization unit 121, to the lossless encoding unit 106.

The lossless encoding unit 106 performs lossless encoding such as variable-length coding or arithmetic coding with respect to the quantized transform coefficient.

The lossless encoding unit 106 acquires information or the like that indicates intra-prediction from the intra-prediction unit 114 and acquires information that indicates an inter-prediction mode, motion vector information, and the like from the motion prediction and compensation unit 115. The information that indicates intra-prediction (intra-frame prediction) is hereinafter also referred to as intra-prediction mode information. Moreover, the information that indicates an inter-prediction (inter-frame prediction) mode is hereinafter also referred to as an inter-prediction mode.

The lossless encoding unit 106 encodes the quantized transform coefficient and incorporates (multiplexes) various types of information such as a filter coefficient, the intra-prediction mode information, the inter-prediction mode information, and the quantization parameter as part of the header information of the encoded data. The lossless encoding unit 106 supplies the encoded data obtained by encoding to the storage buffer 107 which stores the encoded data.

For example, the lossless encoding unit 106 performs a lossless encoding process such as variable-length coding or arithmetic coding. An example of the variable-length coding includes context-adaptive variable length coding (CAVLC) which is defined in the H.264.AVC scheme. An example of the arithmetic coding includes context-adaptive binary arithmetic coding (CABAC).

The storage buffer 107 temporarily stores the encoded data supplied from the lossless encoding unit 106 and outputs the encoded data to a recording device (not illustrated) transmission path, or the like which is on the downstream side, for example, at a predetermined timing as an encoded image that is encoded according to the H.264.AVC scheme.

Moreover, the transform coefficient quantized in the quantization unit 105 is also supplied to the dequantization unit 108. The dequantization unit 108 dequantizes the quantized transform coefficient according to a method corresponding to the quantization of the quantization unit 105.

It should be noted that the dequantization for the extended macroblock of the chrominance signal is performed by the extended macroblock chrominance dequantization unit 122. The dequantization unit 108 supplies offset information and the orthogonal transform coefficient for the extended macroblock of the chrominance signal to the extended macroblock chrominance dequantization unit 122 which then performs dequantization, and the dequantization unit 108 acquires the orthogonal transform coefficient.

The dequantization unit 108 supplies the transform coefficient, which is generated by the dequantization unit 108 or generated by the extended macroblock chrominance dequantization unit 122, to the inverse orthogonal transform unit 109.

The inverse orthogonal transform unit 109 performs inverse orthogonal transform on the supplied transform coefficient according to a method corresponding to the orthogonal transform process of the orthogonal transform unit 104. The output (reconstructed difference information) obtained through the inverse orthogonal transform is supplied to the computing unit 110.

The computing unit 110 adds the prediction image supplied from the intra-prediction unit 114 or the motion prediction and compensation unit 115 via the selecting unit 115 to the inverse orthogonal transform result (that is, the reconstructed difference information) supplied from the inverse orthogonal transform unit 109 to obtain a locally decoded image (decoded image).

For example, when the difference information corresponds to an image which is subject to intra'-coding, the computing unit 110 adds the prediction image supplied from the intra-prediction unit 114 to the difference information. Moreover, for example, when the difference information corresponds to an image which is subject to inter-coding, the computing unit 110 adds the prediction image supplied from the motion prediction and compensation unit 115 to the difference information.

The addition result is supplied to the deblocking filter 111 or the frame memory 112.

The deblocking filter 111 removes a block distortion of the decoded image by appropriately performing a deblocking filter process and improves image quality by appropriately performing a loop filter process using a Wiener filter, for example. The deblocking filter 111 classifies respective pixels into classes and performs an appropriate filter process for each class. The deblocking filter 111 supplies the filtering result to the frame memory 112.

The frame memory 112 outputs a stored reference image to the intra-prediction unit 114 or the motion prediction and compensation unit 115 via the selecting unit 113 at predetermined timing.

For example, in the case of an image which is subject to intra-coding, the frame memory 112 supplies the reference image to the intra-prediction unit 114 via the selecting unit 113. Moreover, in the case of an image which is subject to inter-coding, the frame memory 112 supplies the reference image to the motion prediction and compensation unit 115 via the selecting unit 113.

When the reference image supplied from the frame memory 112 is an image which is subject to intra-coding, the selecting unit 113 supplies the reference image to the intra-prediction unit 114. Moreover, when the reference image supplied from the frame memory 112 is an image which is subject to inter-coding, the selecting unit 113 supplies the reference image to the motion prediction and compensation unit 115.

The intra-prediction unit 114 performs intra-prediction (intra-frame prediction) of generating a prediction image using the pixel values within a frame. The intra-prediction unit 114 performs intra-prediction using multiple modes (intra-prediction modes).

The intra-prediction unit 114 generates the prediction image in all intra-prediction modes, evaluates the respective prediction images, and selects an optimal mode. Upon selecting an optimal intra-prediction mode, the intra-prediction unit 114 supplies the prediction image generated in the optimal mode to the computing unit 103 and the computing unit 110 via the selecting unit 115.

Moreover, as described above, the intra-prediction unit 114 supplies information such as intra-prediction mode information that indicates the employed intra-prediction mode appropriately to the lossless encoding unit 106.

The motion prediction and compensation unit 115 performs motion prediction with respect to an image which is subject to inter-coding using the input image supplied from the frame rearrangement buffer 102 and the reference image supplied from the frame memory 112 via the selecting unit 113, and performs a motion compensation process according to the detected motion vector to generate the prediction image (inter-prediction image information).

The motion prediction and compensation unit 115 performs the inter-prediction process in all candidate inter-prediction modes to generate the prediction images. The motion prediction and compensation unit 115 supplies the generated prediction images to the computing unit 103 and the computing unit 110 via the selecting unit 116.

Moreover, the motion prediction and compensation unit 115 supplies the inter-prediction mode information that indicates the employed inter-prediction mode and the motion vector information that indicates the calculated motion vector to the lossless encoding unit 106.

In the case of an image which is subjected to the intra-coding, the selecting unit 116 supplies the output of the intra-prediction unit 114 to the computing unit 103 and the computing unit 110. In the case of the image which is subjected to the inter-coding, the selecting unit 116 supplies the output of the motion prediction and compensation unit 115 to the computing unit 103 and the computing unit 110.

The rate control unit 117 controls the rate of the quantization operation of the quantization unit 105 based on the compressed image stored in the storage buffer 107 so that an overflow or an underflow does not occur.

### [Offset Parameter]

In the AVC encoding scheme or the like, as described above, the user adjusts the amount of bits allocated to the chrominance signal using chrominance_qp_index_offset which is the offset parameter included in the picture parameter set. The image encoding device 100 further provides a new offset parameter, chrominance_qp_index_offset_extmb. The chrominance_qp_index_offset_extmb is an offset parameter that designates an offset value (an offset value applied to only a quantization process for an area having a predetermined size or more) of the quantization parameter for the extended macroblock of the chrominance signal. This offset parameter enables the relation illustrated in FIG. 8 to be shifted to the right or the left according to the value thereof similarly to the chrominance_qp_index_offset. That is, the offset parameter is a parameter that increases or decreases the quantization parameter for the extended macroblock of the chrominance signal from the value of the quantization parameter for the luminance signal.

The chrominance_qp_index_offset_extmb is stored in the picture parameter set for the P-picture and the B-picture within the encoded data (code stream), for example, and transmitted to an image decoding device.

That is, for example, in the quantization process for the chrominance signal of a motion compensation partition having a size equal to or smaller than 16×16 pixels illustrated in FIG. 3, similarly to the offset value defined in the AVC encoding scheme or the like, the chrominance_qp_index_offset is applied as the offset value. However, for example, in the quantization process for the chrominance signal of a motion compensation partition that is greater than 16×16 pixels, as illustrated in FIG. 7, the chrominance_qp_index_offset_extmb is applied as the offset value.

In this manner, by providing and using a new offset value, chrominance_qp_index_offset_extmb for the quantization process for the extended macroblock (an extended motion compensation partition) of the chrominance signal, the relation between the quantization parameter of the luminance signal and the quantization parameter of the chrominance signal can be corrected independently from the other quantization parameters. In this way, it is possible to set the quantization parameter for the chrominance signal of the extended macroblock more freely. As a result, it is possible to improve the degree of freedom of allocating bits to the chrominance signal of the extended macroblock.

For example, by setting the value of chrominance_qp_index_offset_extmb to be greater than that of chrominance_qp_index_offset (chrominance_qp_index_offset_extmb>chrominance_qp_index_offset), it is possible to allocate more bits to the chrominance signal of a motion compensation partition having an extended size and to prevent deterioration thereof. In this case, since more bits can be allocated to only the portion of the extended macroblock (an extended motion compensation partition) in which visual influence due to an error of the motion information is relatively great, it is possible to suppress the coding efficiency from decreasing unnecessarily.

Practically, if the amount of bits allocated to the chrominance signal is decreased, since the image quality may further deteriorate, the value of chrominance_qp_index_offset_extmb may be inhibited from being set to be smaller than the value of chrominance_qp_index_offset (chrominance_qp_index_offset_extmb<chrominance_qp_index_offset). For example, the storage buffer 107 may be inhibited from outputting chrominance_qp_index_offset_extmb having a value smaller than the value of chrominance_qp_index_offset. Moreover, for example, the lossless encoding unit 106 may be inhibited from adding chrominance_qp_index_offset_extmb having a value smaller than the value of the chrominance_qp_index_offset to the encoded data (picture parameter set or the like)

Moreover, in this case, setting the value of chrominance_qp_index_offset_extmb to be equal to the value of chrominance_qp_index_offset (chrominance_qp_index_offset_extmb chrominance_qp_index_offset) may be permitted or inhibited.

Further, similarly to the case of chrominance_qp_index_offset in High Profile of the AVC encoding scheme, the value of chrominance_qp_index_offset_extmb may be set independently for the chrominance signal Cb and the chrominance signal Cr.

The values of chrominance_qp_index_offset_extmb and chrominance_qp_index_offset may be determined in the following manner, for example.

That is, for example, as a first step, the image encoding device 100 calculates a variance value (activity) of the pixel values of the luminance signal and the chrominance signal included in all macroblocks included in the frame. With regard to the chrominance signal, the activity may be calculated independently for the Cb component and the Cr component.

Is a second step, the image encoding device 100 classifies macroblocks into classes which include macroblocks in which the value of an activity MBAct_{Luma} for the luminance signal is greater than a predetermined threshold value Θ (MBAct_{Luma}>Θ) and the other macroblocks.

The macroblocks belonging to the second class have a lower activity and are expected to be encoded as extended macroblocks.

As a third step, the image encoding device 100 calculates average values AvgAct_{Chroma}_{_{—}}₁ and AvgAct_{Chroma}_{_{—}}₂ of the chrominance signal activities for the first and second classes. The image encoding device 100 determines chrominance_qp_index_offset_extmb based on the value of AvgAct_{Chroma}_{_{—}}₂ according to a table prepared in advance. Moreover, the image encoding device 100 may determine the value of chrominance_qp_index_offset based on the value of AvgAct_{Chroma}_{_{—}}₁. Moreover, the image encoding device 100 may perform the above processing separately for the Cb component and the Cr component when chrominance_qp_index_offset_extmb is determined independently for the Cb component and the Cr component.

### [Quantization Unit]

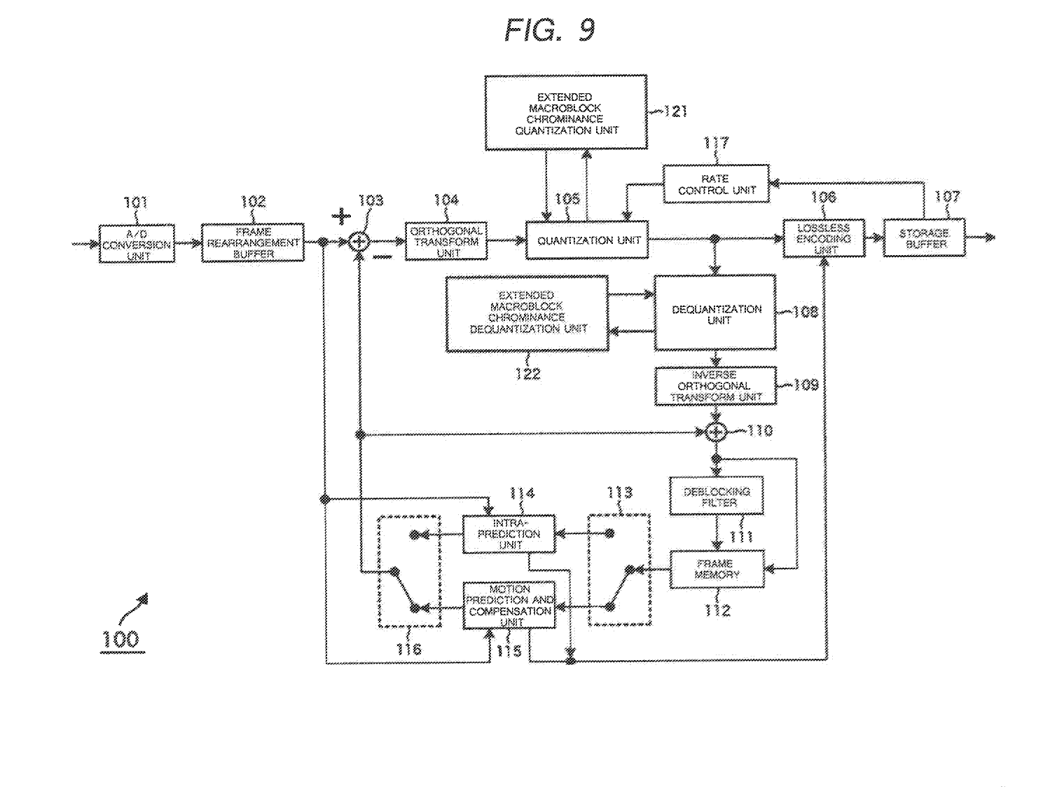

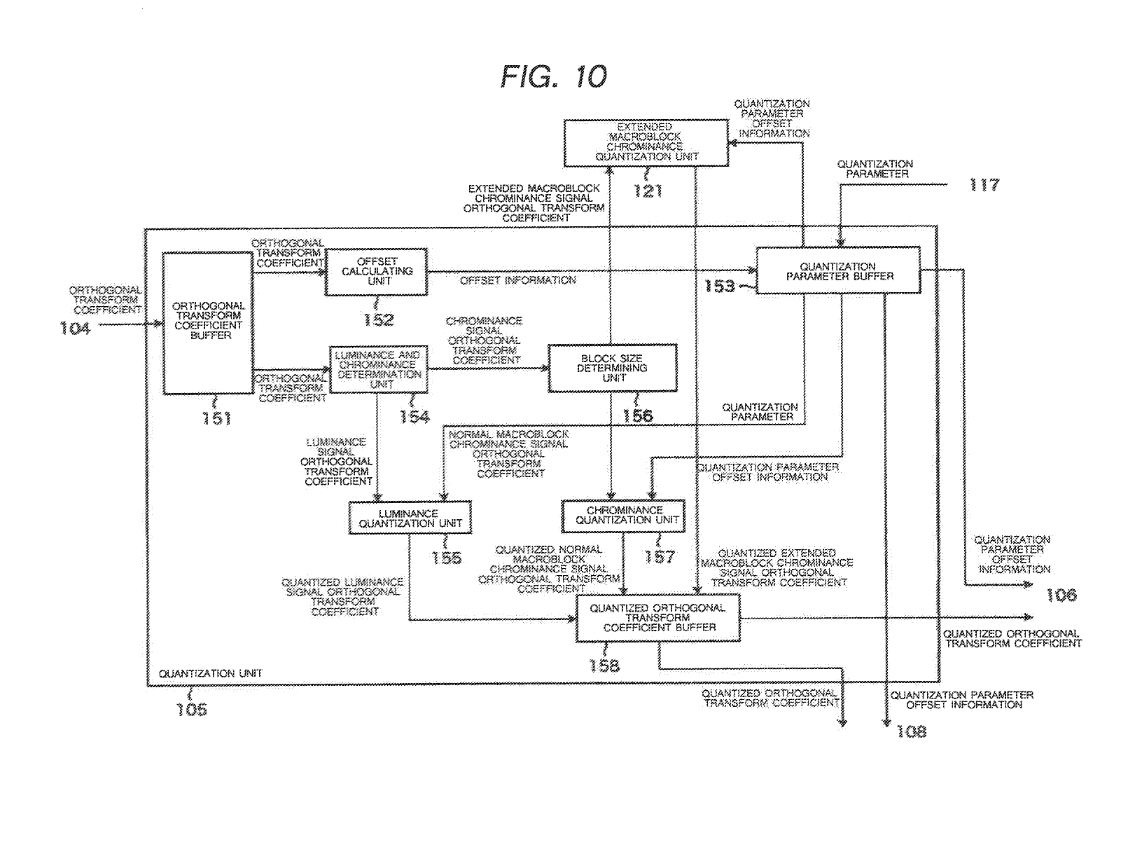

FIG. 10 is a block diagram illustrating a detailed configuration example of the quantization unit 105 of FIG. 9.

As illustrated in FIG. 10, the quantization unit 105 includes an orthogonal transform coefficient buffer 151, an offset calculating unit 152, a quantization parameter buffer 153, a luminance and chrominance determination unit 154, a luminance quantization unit 155, a block size determining unit 156, a chrominance quantization unit 157, and a quantized orthogonal transform coefficient buffer 158.

The luminance signal, the chrominance signal, and the quantization parameter for the chrominance signal of an extended block are supplied from the rate control unit 117 to and stored in the quantization parameter buffer 153.

Moreover, the orthogonal transform coefficient output from the orthogonal transform unit 104 is supplied to the orthogonal transform coefficient buffer 151. The orthogonal transform coefficient is supplied from the orthogonal transform coefficient buffer 151 to the offset calculating unit 152. As described above, the offset calculating unit 152 calculates chrominance_qp_index_offset_extmb and chrominance_qp_index_offset_extmb from the activities of the luminance signal and the chrominance signal. The offset calculating unit 152 supplies the values thereof to the quantization parameter buffer 153, which stores the values.

The quantization parameter stored in the quantization parameter buffer 153 is supplied to the luminance quantization unit 155, the chrominance quantization unit 157, and the extended macroblock chrominance quantization unit 121. Moreover, in this case, the value of the offset parameter chrominance_qp_index_offset is also supplied to the chrominance quantization unit 157. Further, the value of the offset parameter chrominance_qp_index_offset_extmb is also supplied to the extended macroblock chrominance quantization unit 121.

Moreover, the orthogonal transform coefficient output from the orthogonal transform unit 104 is also supplied to the luminance and chrominance determination unit 154 via the orthogonal transform coefficient buffer 151. The luminance and chrominance determination unit 154 identifies whether the orthogonal transform coefficient is for the luminance signal or for the chrominance signal and classifies the orthogonal transform coefficient. When the orthogonal transform coefficient is determined to be for the luminance signal, the luminance and chrominance determination unit 154 supplies the orthogonal transform coefficient of the luminance signal to the luminance quantization unit 155.

The luminance quantization unit 155 quantizes the orthogonal transform coefficient of the luminance signal using the quantization parameter supplied from the quantization parameter buffer to obtain a quantized orthogonal transform coefficient and supplies the quantized orthogonal transform coefficient of the luminance signal to the quantized orthogonal transform coefficient buffer 158 which stores the quantized orthogonal transform coefficient.

Moreover, when the luminance and chrominance determination unit 154 determines that the supplied orthogonal transform coefficient is not for the luminance signal (but the orthogonal transform coefficient of the chrominance signal), the luminance and chrominance determination unit 154 supplies the orthogonal transform coefficient of the chrominance signal to the block size determining unit 156.

The block size determining unit 156 determines a block size of the supplied orthogonal transform coefficient of the chrominance signal. When the block size is determined to be a normal macroblock, the block size determining unit 156 supplies the orthogonal transform coefficient of the chrominance signal of the normal macroblock to the chrominance quantization unit 157.

The chrominance quantization unit 157 corrects the supplied quantization parameter with the similarly supplied offset parameter chrominance_qp_index_offset and quantizes the orthogonal transform coefficient of the chrominance signal of the normal macroblock using the corrected quantization parameter. The chrominance quantization unit 157 supplies the quantized orthogonal transform coefficient of the chrominance signal of the normal macroblock to the quantized orthogonal transform coefficient buffer 158, which stores the quantized orthogonal transform coefficient.

Further, when the supplied orthogonal transform coefficient of the chrominance signal is determined to be for the extended macroblock, the block size determining unit 156 supplies the orthogonal transform coefficient of the chrominance signal of the extended macroblock to the extended macroblock chrominance quantization unit 121.

The extended macroblock chrominance quantization unit 121 corrects the supplied quantization parameter with the similarly supplied offset parameter chrominance_qp_index_offset_extmb and quantizes the orthogonal transform coefficient of the chrominance signal of the extended macroblock using the corrected quantization parameter. The extended macroblock chrominance quantization unit 121 supplies the quantized orthogonal transform coefficient of the chrominance signal of the extended macroblock to the quantized orthogonal transform coefficient buffer 158, which stores the quantized orthogonal transform coefficient.

The quantized orthogonal transform coefficient buffer 158 supplies the quantized orthogonal transform coefficient stored therein to the lossless encoding unit 106 and the dequantization unit 108 at a predetermined timing. Moreover, the quantization parameter buffer 153 supplies the quantization parameter and the offset information stored therein to the lossless encoding unit 106 and the dequantization unit 108 at a predetermined timing.

The dequantization unit 108 has the same configuration as the dequantization unit of an image decoding device and performs the same process. Thus, the dequantization unit 108 will be described when describing the image decoding device.

### [Encoding Process Flow]

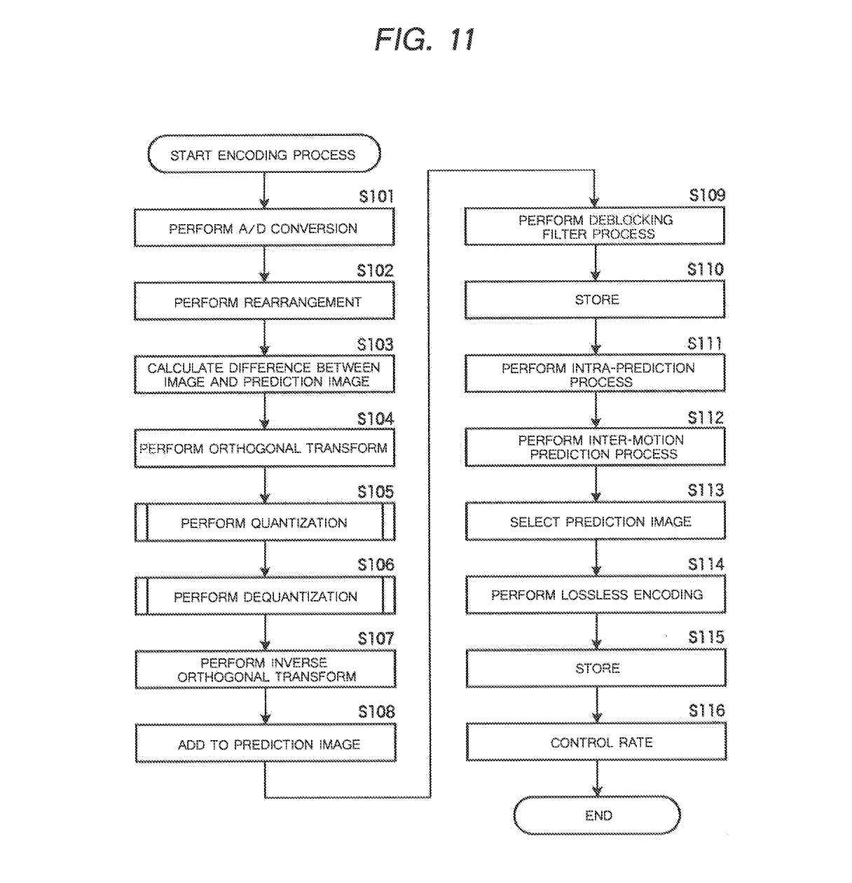

Next, the flow of respective processes executed by the image encoding device 100 will be explained. First, an example of the flow of an encoding process will be explained with reference to the flowchart of FIG. 11.

In step S101, the A/D conversion unit 101 performs A/D conversion on an input image. In step S102, the frame rearrangement buffer 102 stores the A/D converted image and rearranges the respective pictures from the display order to the encoding order.

In step S103, the computing unit 103 computes a difference between the image rearranged by the process of step S102 and the prediction image. When an image is subject to inter-prediction, the prediction image is supplied from the motion prediction and compensation unit 115 to the computing unit 103 via the selecting unit 116. When an image is subject to intra-prediction, the prediction image is supplied from the intra-prediction unit 114 to the computing unit 103 via the selecting unit 116.

The difference data has a data amount that is reduced from that of original image data. Thus, it is possible to compress the data amount as compared to when the image is encoded at it is.

In step S104, the orthogonal transform unit 104 performs orthogonal transform on the difference information generated by the process of step S103. Specifically, orthogonal transform such as discrete cosine transform or Karhunen-Loeve transform is performed, and a transform coefficient is output.

In step S105, the quantization unit 105 quantizes the orthogonal transform coefficient obtained by the process of step S104.

The difference information quantized by the process of step S105 is locally decoded in the following manner. That is, in step S106, the dequantization unit 108 dequantizes the quantized orthogonal transform coefficient (also referred to as a quantization coefficient) generated by the process of step S105 according to a property corresponding to the property of the quantization unit 105. In step S107, the inverse orthogonal transform unit 109 performs inverse orthogonal transform on the orthogonal transform coefficient obtained by the process of step S106 according to a property corresponding to the property of the orthogonal transform unit 104.

In step S108, the computing unit 110 adds the prediction image to the difference information that is locally decoded to generate a locally decoded image (the image corresponding to the input to the computing unit 103). In step S109, the deblocking filter 111 performs filtering on the image generated by the process of step S108. In this way, a block distortion is removed.

In step S110, the frame memory 112 stores the image in which the block distortion is removed by the process of step S109. Into the frame memory 112, the image which is not subject to the filtering process of the deblocking filter 111 is also supplied from the computing unit 110 and stored.

In step S111, the intra-prediction unit 114 performs an intra-prediction process in the intra-prediction mode. In step S112, the motion prediction and compensation unit 115 performs an inter-motion prediction process of performing motion prediction and motion compensation in the inter-prediction mode.

In step S113, the selecting unit 116 determines an optimal prediction mode based on the respective cost function values output from the intra-prediction unit 114 and the motion prediction and compensation unit 115. That is, the selecting unit 116 selects any one of the prediction image generated by the intra-prediction unit 114 and the prediction image generated by the motion prediction and compensation unit 115.

Moreover, selection information that indicates which prediction image is selected is supplied to one of the intra-prediction unit 114 and the motion prediction and compensation unit 115 of which prediction image has been selected. When the prediction image of the optimal intra-prediction mode is selected, the in unit 114 supplies information (that is, intra-prediction mode information) that indicates an optimal intra-prediction mode, to the lossless encoding unit 106.

When the prediction image of the optimal inter-prediction mode is selected, the motion prediction and compensation unit 115 outputs the information that indicates the optimal inter-prediction mode and if necessary, the information corresponding to the optimal inter-prediction mode, to the lossless encoding unit 106. An example of the information corresponding to the optimal inter-prediction mode includes motion vector information, flag information, and reference frame information.

In step S114, the lossless encoding unit 106 encodes the transform coefficient quantized by the process of step S105. That is, lossless encoding such as variable-length coding or arithmetic coding is performed on the difference image (a secondary difference image in the case of inter-coding).

The lossless encoding unit 106 encodes the quantization parameter, the offset information, and the like used in the quantization process of step S105 and adds the encoded parameter and information to the encoded data. Moreover, the lossless encoding unit 106 also encodes the intra-prediction mode information supplied from the intra-prediction unit 114 or the information corresponding to the optimal inter-prediction mode supplied from the motion prediction and compensation unit 115 and adds the encoded information to the encoded data.

In step S115, the storage buffer 107 stores the encoded data output from the lossless encoding unit 106. The encoded data stored in the storage buffer 107 is appropriately read and transmitted to a decoding side via a transmission path.

In step S116, the rate control unit 117 controls the rate of the quantization operation of the quantization unit 105 based on the compressed image stored in the storage buffer 107 by the process of step S115 so that an overflow or an underflow does not occur.

When the process of step S116 ends, the encoding process ends

### [Quantization Process Flow]

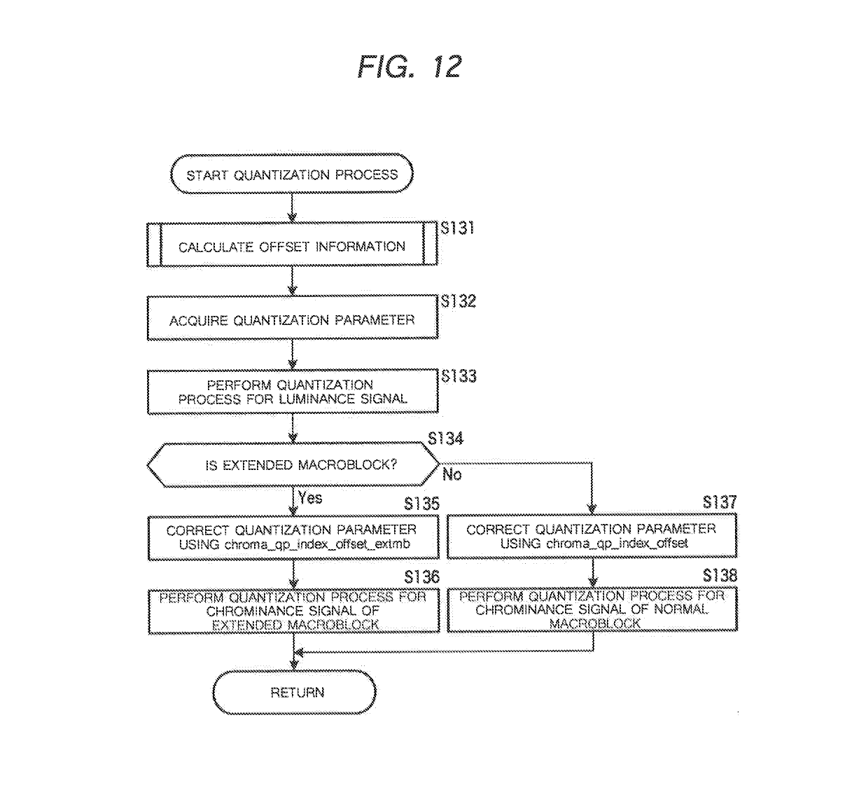

Next, an example of the flow of the quantization process executed in step S105 of FIG. 11 will be explained with reference to the flowchart of FIG. 12.

When the quantization process starts, in step S131, the offset calculating unit 152 calculates the values of chrominance_qp_index_offset_extmb and chrominance_qp_index_offset_extmb which are offset information using the orthogonal transform coefficient generated by the orthogonal transform unit 104.

In step S132, the quantization parameter buffer 153 acquires the quantization parameter from the rate control unit 117. In step S133, the luminance quantization unit 155 quantizes the orthogonal transform coefficient of the luminance signal which is determined to be the luminance signal by the luminance and chrominance determination unit 154 using the quantization parameter acquired by the process of step S132.

In step S134, the block size determining unit 156 determines whether a current macroblock is an extended macroblock, and when the macroblock is determined to be an extended macroblock, the process flow proceeds to step S135.

In step S135, the extended macroblock chrominance quantization unit 121 corrects the value of the quantization parameter acquired in step S132 using the chrominance_qp_index_offset_extmb calculated in step S131. More specifically, a predetermined relation between the quantization parameter of the luminance signal and the quantization parameter of the chrominance signal is corrected using the chrominance_qp_index_offset_extmb, and the quantization parameter for the chrominance signal of the extended macroblock is generated from the quantization parameter of the luminance signal based on the corrected relation.

In step S136, the extended macroblock chrominance quantization unit 121 performs a quantization process on the chrominance signal of the extended macroblock using the corrected quantization parameter obtained by the process of step S135. When the process of step S136 ends, the quantization unit 105 ends the quantization process, the process flow returns to step S106 of FIG. 11, and the process of step S107 and the subsequent process are executed.

Moreover, when it is determined in step S134 of FIG. 12 that the macroblock is a normal macroblock, the block size determining unit 156 proceeds to step S137.

In step S137, the chrominance quantization unit 157 corrects the value of the quantization parameter acquired in step S132 using the chrominance_qp_index_offset calculated by the process of step S131. More specifically, a predetermined relation between the quantization parameter of the luminance signal and the quantization parameter of the chrominance signal is corrected using the chrominance_qp_index_offset, and the quantization parameter for the chrominance signal of the normal macroblock is generated from the quantization parameter of the luminance signal based on the corrected relation.

In step S138, the chrominance quantization unit 157 performs a quantization process on the chrominance signal of the normal macroblock using the corrected quantization parameter obtained by the process of step S137. When the process of step S138 ends, the quantization unit 105 ends the quantization process, the process flow returns to step S106 of FIG. 11, and the process of step S107 and the subsequent process are executed.

### [Offset Information Calculating Process]

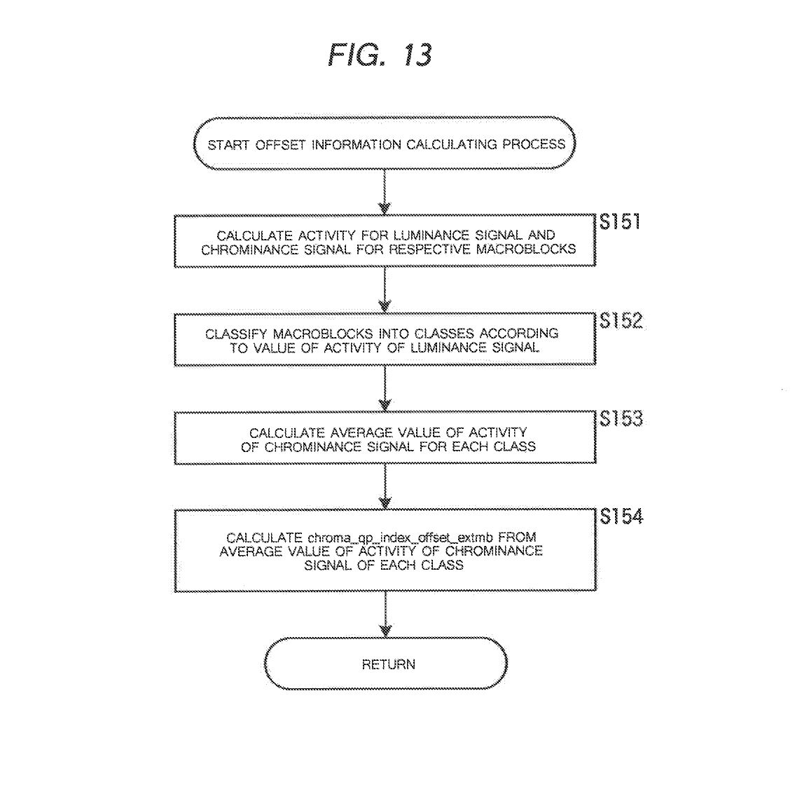

Next, an example of the flow of an offset information calculating process executed in step S131 of FIG. 12 will be explained with reference to the flowchart of FIG. 13.

When the offset information calculating process starts, in step S151, the offset calculating unit 152 calculates the activities (variance values of pixels) of the luminance signal and the chrominance signal for the respective macroblocks.

In step S152, the offset calculating unit 152 classifies the macroblocks according to the value of the activity of the luminance signal calculated in step S151 into classes.

In step S153, the offset calculating unit 152 calculates the average value of the activities of the chrominance signal for each class.

In step S154, the offset information chrominance_qp_index_offset and the offset information chrominance_qp_index_offset_extmb are calculated based on the average value of the activities of the chrominance signal for each class, calculated by the process of step S153.

When the offset information is calculated, the offset calculating unit 152 ends the offset information calculating process, the process flow returns to step S131 in FIG. 12, and the subsequent process is executed.

By performing the respective processes in this way, the image encoding device 100 can allocate more bits to the extended macroblock of the chrominance signal. As described above, it is possible to suppress image quality deterioration while suppressing an unnecessary decrease of the coding efficiency.

Further, the dequantization process executed in FIG. 11 is the same as the dequantization process of the image decoding device described later, and the description thereof will not be provided.

### 2. Second Embodiment

### [Image Decoding Device]

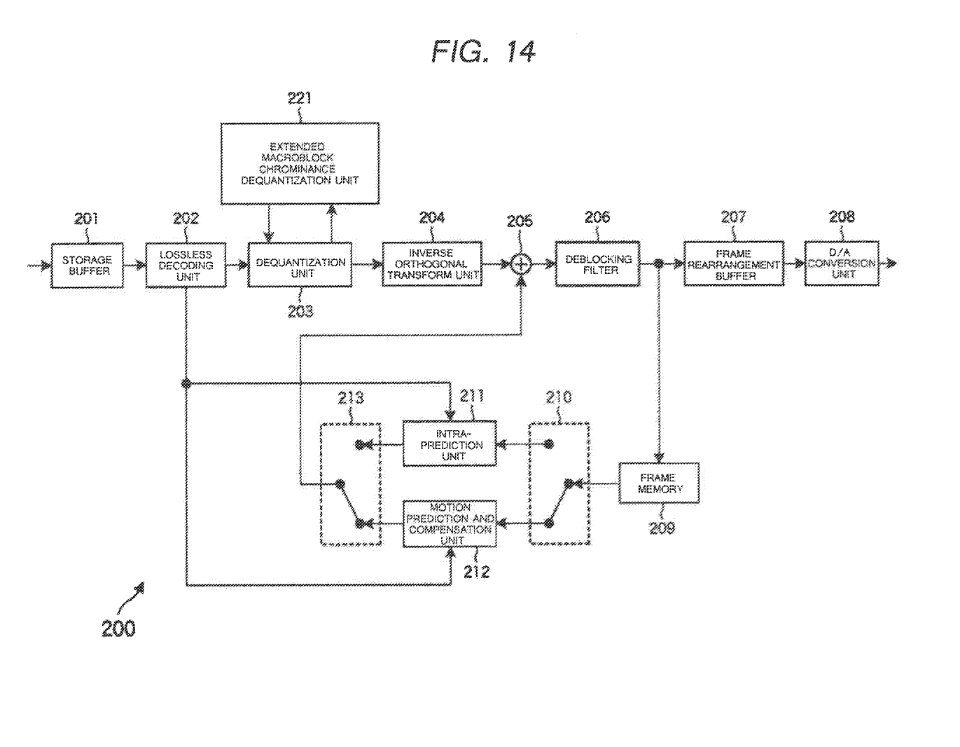

FIG. 14 is a block diagram illustrating a main configuration example of an image decoding device. An image decoding device 200 illustrated in FIG. 14 is a decoding device corresponding to the image encoding device 100.

The encoded data encoded by the image encoding device 100 is transmitted to and decoded by the image decoding device 200 corresponding to the image encoding device 100 via a predetermined transmission path.

As illustrated in FIG. 14, the image decoding device 200 includes a storage buffer 201, a lossless decoding unit 202, a dequantization unit 203, an inverse orthogonal transform unit 204, a computing unit 205, a deblocking filter 206, a frame rearrangement buffer 207, and a D/A conversion unit 208. Moreover, the image decoding device 200 includes a frame memory 209, a selecting unit 210, an intra-prediction unit 211, a motion prediction and compensation unit 212, and a selecting unit 213.

The image decoding device 200 further includes an extended macroblock chrominance dequantization unit 221

The storage buffer 201 stores transmitted encoded data. The encoded data is encoded by the image encoding device 100. The lossless decoding unit 202 decodes the encoded data read from the storage buffer 201 at a predetermined timing according to a scheme corresponding to the encoding scheme of the lossless encoding unit 106 of FIG. 1.

The lossless decoding unit 202 supplies the coefficient data obtained by decoding the encoded data to the dequantization unit 203.

The dequantization unit 203 dequantizes the coefficient data (quantization coefficient) obtained by being decoded by the lossless decoding unit 202 according to a scheme corresponding to the quantization scheme of the quantization unit 105 of FIG. 1. In this case, the dequantization unit 203 performs dequantization on the extended macroblock of the chrominance signal using the extended macroblock chrominance dequantization unit 221.

The dequantization unit 203 supplies the dequantized coefficient data (that is, the orthogonal transform coefficient) to the inverse orthogonal transform unit 204. The inverse orthogonal transform unit 204 performs inverse orthogonal transform on the orthogonal transform coefficient according to a scheme corresponding to the orthogonal transform scheme of the orthogonal transform unit 104 of FIG. 1 and obtains decoded residual data corresponding to residual data which has not been subject to the orthogonal transform of the image encoding device 100.

The decoded residual data obtained through inverse orthogonal transform is supplied to the computing unit 205. Moreover, the prediction image is supplied to the computing unit 205 from the intra-prediction unit 211 or the motion prediction and compensation unit 212 via the selecting unit 213.

The computing unit 205 adds the decoded residual data and the prediction image, and obtains decoded image data corresponding to the image data which has not been subtracted by the prediction image by the computing unit 103 of the image encoding device 100. The computing unit 205 supplies the decoded image data to the deblocking filter 206.

The deblocking filter 206 removes a block distortion of the supplied decoded image and then supplies the decoded image to the frame rearrangement buffer 207.

The frame rearrangement buffer 207 performs frame rearrangement. That is, the order of frames arranged for encoding by the frame rearrangement buffer 102 of FIG. 1 is rearranged to the original display order. The D/A conversion unit 208 performs D/A conversion on the image supplied from the frame rearrangement buffer 207 and outputs the converted image to a display (not illustrated), which displays the image.

The output of the deblocking filter 206 is also supplied to the frame memory 209.

The frame memory 209, the selecting unit 210, the intra-prediction unit 211, the motion prediction and compensation unit 212, and the selecting unit 213 correspond respectively to the frame memory 112, the selecting unit 113, the intra-prediction unit 114, the motion prediction and compensation unit 115, and the selecting unit 116 of the image encoding device 100.

The selecting unit 210 reads an image which is subject to inter-prediction and referenced images from the frame memory 209 and supplies the images to the motion prediction and compensation unit 212. Moreover, the selecting unit 210 reads images used for intra-prediction from the frame memory 209 and supplies the images to the intra-prediction unit 211.

Header information that indicates the intra-prediction mode obtained by decoding high-frequency noise is appropriately supplied to the intra-prediction unit 211 from the lossless decoding unit 202. The intra-prediction unit 211 generates a prediction image from the reference images acquired from the frame memory 209 based on this information and supplies the generated prediction image to the selecting unit 213.

The motion prediction and compensation unit 212 acquires the information (prediction mode information, motion vector information, reference frame information, flags, and various parameters) obtained by decoding the header information from the lossless decoding unit 202.

The motion prediction and compensation unit 212 generates a prediction image from the reference images acquired from the frame memory 209 based on these items of information supplied from the lossless decoding unit 202 and supplies the generated prediction image to the selecting unit 213.

The selecting unit 213 selects the prediction image generated by the motion prediction and compensation unit 212 or the intra-prediction unit 211 and supplies the selected prediction image to the computing unit 205.

The extended macroblock chrominance dequantization unit 221 performs dequantization on the extended macroblock of the chrominance signal in cooperation with the dequantization unit 203.

In the case of the image decoding device 200, the quantization parameter and the offset information are supplied from the image encoding device 100 (the lossless decoding unit 202 extracts the quantization parameter and the offset information from code stream)

### [Dequantization Unit]

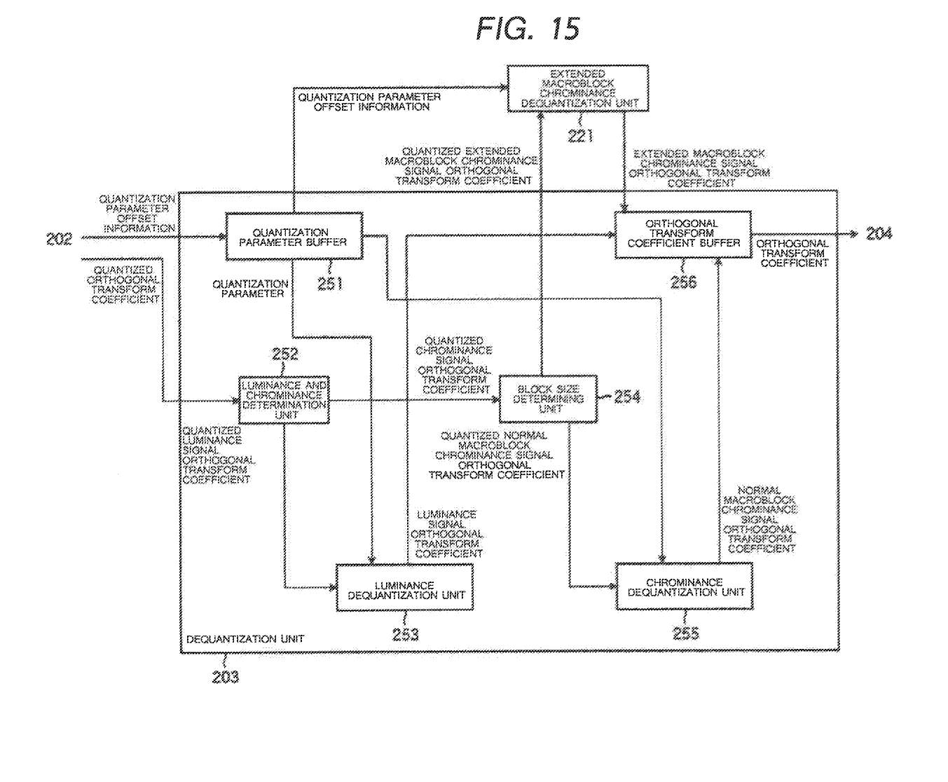

FIG. 15 is a block diagram illustrating a detailed configuration example of the dequantization unit 203. As illustrated in FIG. 15, the dequantization unit 203 includes a quantization parameter buffer 251, a luminance and chrominance determination unit 252, a luminance dequantization unit 253, a block size determining unit 254, a chrominance dequantization unit 255, and an orthogonal transform coefficient buffer 256.

First, from the lossless decoding unit 202, the quantization parameter, the offset information, and the like are supplied to and stored in the quantization parameter buffer 251. Moreover, the quantized orthogonal transform coefficient supplied from the lossless decoding unit 202 is supplied to the luminance and chrominance determination unit 252.

The luminance and chrominance determination unit 252 determines whether the quantized orthogonal transform coefficient is for the luminance signal or for the chrominance signal. When the orthogonal transform coefficient is for the luminance signal, the luminance and chrominance determination unit 252 supplies the quantized orthogonal transform coefficient of the luminance signal to the luminance dequantization unit 253. In this case, the quantization parameter buffer 251 supplies the quantization parameter to the luminance dequantization unit 253.

The luminance dequantization unit 253 dequantizes the quantized orthogonal transform coefficient of the luminance signal, supplied from the luminance and chrominance determination unit 252 using the quantization parameter. The luminance dequantization unit 253 supplies the orthogonal transform coefficient of the luminance signal obtained through dequantization to the orthogonal transform coefficient buffer 256, which stores the orthogonal transform coefficient.

Moreover, when the orthogonal transform coefficient is determined to be for the chrominance signal, the luminance and chrominance determination unit 252 supplies the quantized orthogonal transform coefficient of the chrominance signal to the block size determining unit 254. The block size determining unit 254 determines the size of a current macroblock.

When the macroblock is determined to be an extended macroblock, the block size determining unit 254 supplies the quantized orthogonal transform coefficient of the chrominance signal of the extended macroblock to the extended macroblock chrominance dequantization unit 221. In this case, the quantization parameter buffer 251 supplies the quantization parameter and the offset information chrominance_qp_index_offset_extmb to the extended macroblock chrominance dequantization unit 221.

The extended macroblock chrominance dequantization unit 221 corrects the quantization parameter using the offset information chrominance_qp_index_offset_extmb and dequantizes the quantized orthogonal transform coefficient of the chrominance signal of the extended macroblock, supplied from the block size determining unit 254 using the corrected quantization parameter. The extended macroblock chrominance dequantization unit 221 supplies the orthogonal transform coefficient of the chrominance signal of the extended macroblock obtained through dequantization to the orthogonal transform coefficient buffer 256, which stores the orthogonal transform coefficient.

Moreover, when the macroblock is determined to be a normal macroblock, the block size determining unit 254 supplies the quantized orthogonal transform coefficient of the chrominance signal of the normal macroblock to the chrominance dequantization unit 255. In this case, the quantization parameter buffer 251 supplies the quantization parameter and the offset information chrominance_qp_index_offset to the chrominance dequantization unit 255.

The chrominance dequantization unit 255 corrects the quantization parameter using the offset information chrominance_qp_index_offset and dequantizes the quantized orthogonal transform coefficient of the chrominance signal of the normal macroblock, supplied from the block size determining unit 254 using the corrected quantization parameter. The chrominance dequantization unit 255 supplies the orthogonal transform coefficient of the chrominance signal of the normal macroblock obtained through dequantization to the orthogonal transform coefficient buffer 256, which stores the orthogonal transform coefficient.

The orthogonal transform coefficient buffer 256 supplies the orthogonal transform coefficients stored in this way to the inverse orthogonal transform unit 204.

In this manner, the dequantization unit 203 can perform dequantization using the offset information chrominance_qp_index_offset_extmb in correspondence with the quantization process of the image encoding device 100. Thus, it is possible to allocate more bits to the extended macroblock of the chrominance signal where visual influence due to an error of the motion information is likely to increase. Therefore, the image decoding device 200 can suppress image quality deterioration while suppressing an unnecessary decrease of the encoding efficiency.

Further, the dequantization unit 108 of FIG. 9 has basically the same configuration and performs the same process as the dequantization unit 203. However, in the dequantization unit 108, the extended macroblock chrominance dequantization unit 122 instead of the extended macroblock chrominance dequantization unit 221 executes dequantization on the extended macroblock of the chrominance signal. Moreover, the quantization parameter, the quantized orthogonal transform coefficient, and the like are supplied from the quantization unit 105 rather than the lossless decoding unit 202. Further, the orthogonal transform coefficient obtained through dequantization is supplied to the inverse orthogonal transform unit 109 rather than the inverse orthogonal transform unit 204.

### [Decoding Process Flow]

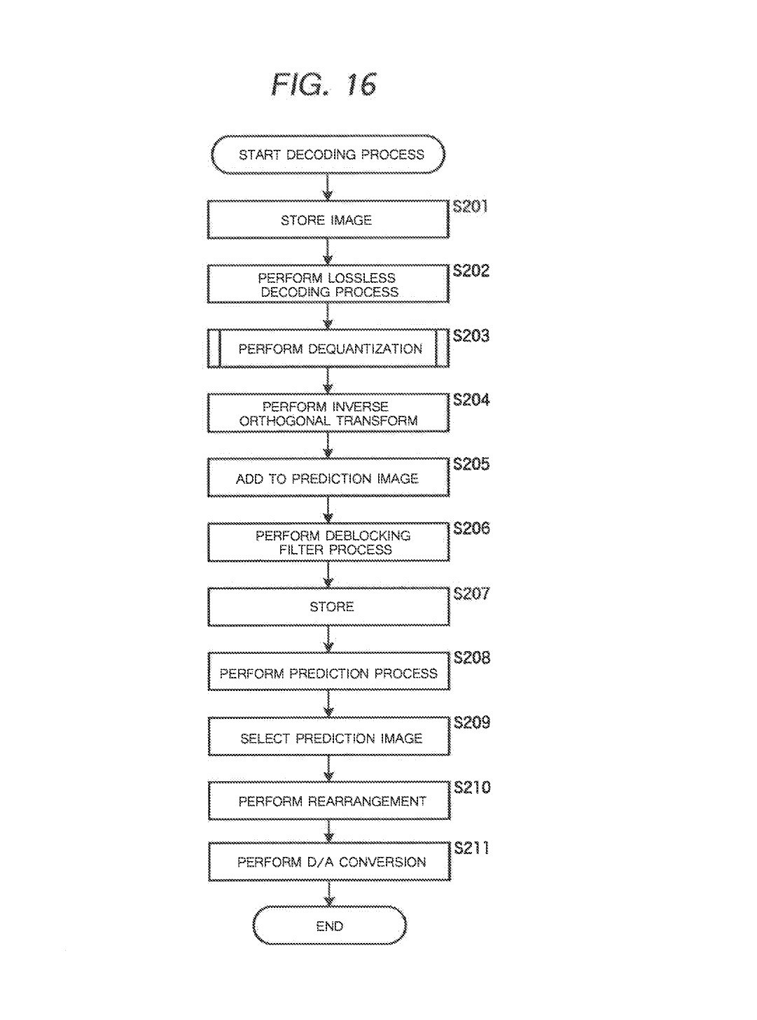

Next, the flow of respective processes executed by the image decoding device 200 having the above configuration will be explained. First, an example of the flow of a decoding process will be explained with reference to the flowchart of FIG. 16.

When the decoding process starts, in step S201, the storage buffer 201 stores transmitted encoded data. In step S202, the lossless decoding unit 202 decodes the encoded data supplied from the storage buffer 201. That is, the I, P, and B-pictures encoded by the lossless encoding unit 106 of FIG. 1 are decoded.

In this case, the motion vector information, the reference frame information, the prediction mode information (the intra-prediction mode or the inter-prediction mode), various flags, the quantization parameter, the offset information, and the like are also decoded.

When the prediction mode information is the intra-prediction mode information, the prediction mode information is supplied to the intra-prediction unit 211. When the prediction mode information is the inter-prediction mode information, the motion vector information corresponding to the prediction mode information is supplied to the motion prediction and compensation unit 212.

In step S203, the dequantization unit 203 dequantizes the quantized orthogonal transform coefficient obtained by being decoded by the lossless decoding unit 202 according to a method corresponding to the quantization process of the quantization unit 105 of FIG. 1. For example, the dequantization unit 203 corrects the quantization parameter with the offset information chrominance_qp_index_offset_extmb using the extended macroblock chrominance dequantization unit 221 during the dequantization for the extended macroblock of the chrominance signal and dequantizes the corrected quantization parameter.

In step S204, the inverse orthogonal transform unit 204 performs inverse orthogonal transform on the orthogonal transform coefficient obtained by being dequantized by the dequantization unit 203 according to a method corresponding to the orthogonal transform process of the orthogonal transform unit 104 of FIG. 1. In this way, the difference information corresponding to the input (the output of the computing unit 103) of the orthogonal transform unit 104 of FIG. 1 is decoded.

In step S205, the computing unit 205 adds the prediction image to the difference information obtained by the process of step S204. In this way, the original image data is decoded.

In step S206, the deblocking filter 206 appropriately performs filtering on the decoded image obtained by the process of step S205. In this way, a block distortion is appropriately removed from the decoded image.

In step S207, the frame memory 209 stores the filtered decoded image.

In step S208, the intra-prediction unit 211 or the motion prediction and compensation unit 212 performs an image prediction process in correspondence with the prediction mode information supplied from the lossless decoding unit 202.

That is, when the intra-prediction mode information is supplied from the lossless decoding unit 202, the intra-prediction unit 211 performs an intra-prediction process in the intra-prediction mode. Moreover, when the inter-prediction mode information is supplied from the lossless decoding unit 202, the motion prediction and compensation unit 212 performs a motion prediction process in the inter-prediction mode.

In step S209, the selecting unit 21′3 selects a prediction image. That is, the prediction image generated by the intra-prediction unit 211 or the prediction image generated by the motion prediction and compensation unit 212 is supplied to the selecting unit 213. The selecting unit 213 selects a side where the prediction image is supplied and supplies the prediction image to the computing unit 205. The prediction image is added to the difference information by the process of step S205.

In step S210, the frame rearrangement buffer 207 rearranges the frames of the decoded image data. That is, the order of frames arranged for encoding by the frame rearrangement buffer 102 (FIG. 1) of the image encoding device 100 is rearranged to the original display order.

In step S211, the D/A conversion unit 208 performs D/A conversion on the decoded image data in which the frames are rearranged by the frame rearrangement buffer 207. The decoded image data is output to a display (not illustrated), and the image thereof is displayed,

### [Dequantization Process Flow]

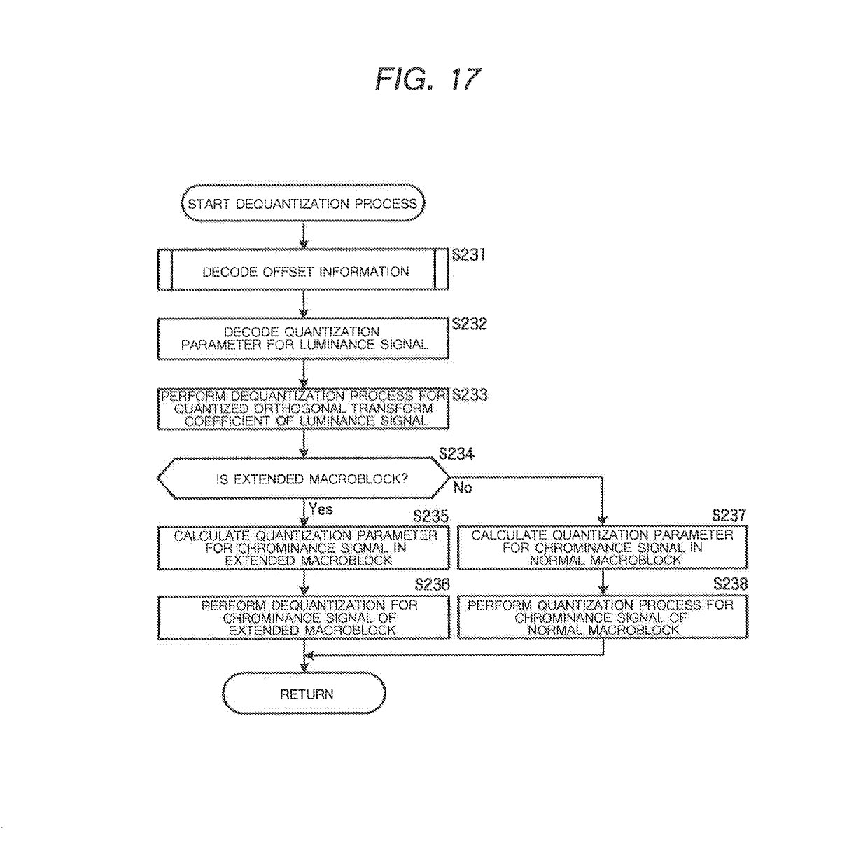

Next, an example of a detailed flow of the dequantization process executed in step S203 of FIG. 16 will be explained with reference to the flowchart of FIG. 17.

When the dequantization process starts, the lossless decoding unit 202 decodes the offset information (chrominance_qp_index_offset and chrominance_qp_index_offset_extmb) in step S231 and decodes the quantization parameter for the luminance signal in step S232.

In step S232, the luminance dequantization unit 253 performs a dequantization process on the quantized orthogonal transform coefficient of the luminance signal. In step S234, the block size determining unit 254 determines whether the current macroblock is an extended macroblock. When the macroblock is determined to be an extended macroblock, the block size determining unit 254 proceeds to step S235.

In step S235, the extended macroblock chrominance dequantization unit 221 corrects the quantization parameter of the luminance signal, decoded by the process of step S232 with the offset information chrominance_qp_index_offset_extmb decoded by the process of step S231 to thereby calculate the quantization parameter for the chrominance signal of the extended macroblock. More specifically, a predetermined relation between the quantization parameter of the luminance signal and the quantization parameter of the chrominance signal is corrected using the chrominance_qp_index_offset_extmb, and the quantization parameter for the chrominance signal of the extended macroblock is generated from the quantization parameter of the luminance signal based on the corrected relation.

In step S236, the extended macroblock chrominance dequantization unit 221 dequantizes the quantized orthogonal transform coefficient of the chrominance signal of the extended macroblock using the quantization parameter calculated by the process of step S235 and generates the orthogonal transform coefficient of the chrominance signal of the extended macroblock.

Moreover, when it is determined in step S234 that the block is a normal macroblock, the block size determining unit 254 proceeds to step S237.

In step S237, the chrominance dequantization unit 255 corrects the quantization parameter for the luminance signal decoded by the process of step S232 with the offset information chrominance_qp_index_offset decoded by the process of step S231 to thereby calculate the quantization parameter for the chrominance signal of the normal macroblock. More specifically, a predetermined relation between the quantization parameter of the luminance signal and the quantization parameter of the chrominance signal is corrected using the chrominance_qp_index_offset, and the quantization parameter for the chrominance signal of the normal macroblock is generated from the quantization parameter of the luminance signal based on the corrected relation.

In step S238, the chrominance dequantization unit 255 dequantizes the quantized orthogonal transform coefficient of the chrominance signal of the normal macroblock using the quantization parameter calculated by the process of step S237 and generates the orthogonal transform coefficient of the chrominance signal of the normal macroblock.

The orthogonal transform coefficients calculated in steps S233, S236, and S238 are supplied to the inverse orthogonal transform unit 204 via the orthogonal transform coefficient buffer 256.

When the process of step S236 or S238 ends, the dequantization unit 203 ends the dequantization process, the process flow returns to step S203 of FIG. 16, and the process of step S204 and the subsequent process are executed.

In this manner, by performing the respective processes, the image decoding device 200 can perform dequantization using the offset information chrominance_qp_index_offset_extmb in correspondence with the quantization process of the image encoding device 100. Thus, it is possible to allocate more bits to the extended macroblock of the chrominance signal where visual influence due to an error of the motion information is likely to increase. Therefore, the image decoding device 200 can suppress image quality deterioration while suppressing an unnecessary decrease of the coding efficiency.

The dequantization process executed in step S106 of the encoding process of FIG. 11 is performed similarly to the dequantization process of the image decoding device 200 described with reference to the flowchart of FIG. 17.

Moreover, in the above description, although the offset information chrominance_qp_index_offset_extmb is applied to the extended macroblock, the size that serves as a boundary regarding whether the offset information chrominance_qp_index_offset or the offset information chrominance_qp_index_offset_extmb will be applied is optional.

For example, with regard to the chrominance signal of a macroblock having a size equal to or smaller than 8×8 pixels, the quantization parameter of the luminance signal may be corrected using the offset information chrominance_qp_index_offset. With regard to the chrominance signal of a macroblock having a size greater than 8×8 pixels, the quantization parameter of the luminance signal may be corrected using the offset information chrominance_qp_index_offset_extmb.

Moreover, for example, the offset information chrominance_qp_index_offset may be applied to the chrominance signal of a macroblock having a size equal to or smaller than 64×64 pixels, and the offset information chrominance_qp_index_offset_extmb may be applied to the chrominance signal of a macroblock having a size greater than 64×64 pixels.

In the above, the image encoding device that performs encoding according to a scheme compatible with the AVC encoding scheme and the image decoding device that performs decoding according to a scheme compatible with the AVC encoding scheme have been described by way of an example. However, the range of application of the present disclosure is not limited to this, and can be applied to all image encoding devices and all image decoding devices which perform an encoding process based on blocks having a hierarchical structure as illustrated in FIG. 7.

Moreover, the quantization parameter and the offset information described above may be added to an optional position of the encoded data, for example, and may be transmitted to a decoding side separately from the encoded data. For example, the lossless encoding unit 106 may describe these items of information in a bit stream as syntax. Moreover, the lossless encoding unit 106 may store these items of information in a predetermined area as supplemental information and transmit the supplemental information. For example, these items of information may be stored in a parameter set (for example, a sequence or the header of pictures) such as supplemental enhancement information (SEI).

Moreover, the lossless encoding unit 106 may transmit these items of information from the image encoding device 100 to the image decoding device 200 separately from the encoded data (as a different file). In this case, a correspondence between these items of information and the encoded data needs to be clarified (to be confirmed on the decoding side), and a method of clarifying the correspondence is optional. For example, table information that indicates the correspondence may be created separately, and link information that indicates corresponding data may be embedded in both data.

### 3. Third Embodiment

### [Personal Computer]

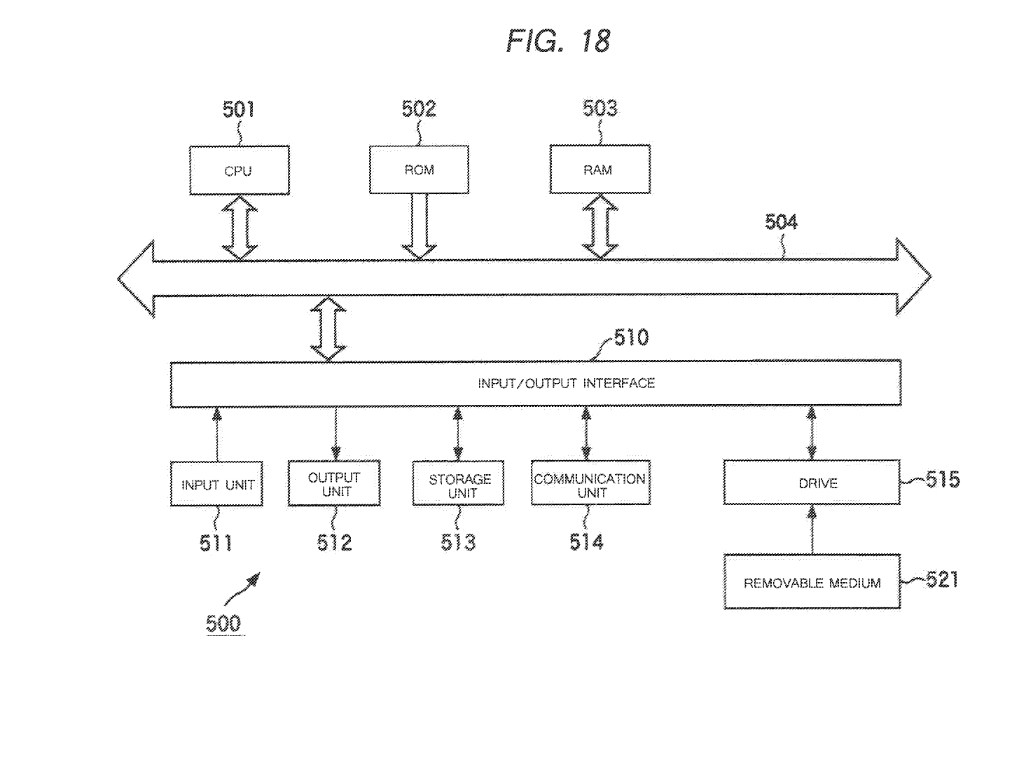

The series of processes described above may be executed by hardware and may be executed by software. In this case, for example, the processes may be realized by a personal computer as illustrated in FIG. 18.

In FIG. 18, a central processing unit (CPU) 501 of a personal computer 500 executes various processes according to a program stored in a read only memory (ROM) 502 or a program loaded into a random access memory (RAM) 503 from a storage unit 513. Data or the like necessary when the CPU 501 executes various processes is also appropriately stored in the RAM 503.

The CPU 501, the ROM 502, and the RAM 503 are connected to each other via a bus 504. An input/output interface 510 is also connected to the bus 504.

The input/output interface 510 is connected to an input unit 511 such as a keyboard and a mouse, an output unit 512 such as a display including a cathode ray tube (CRT) and a liquid crystal display (LCD) and a speaker, a storage unit 513 that is formed of a hard disk, and a communication unit 514 that is formed of a modem or the like. The communication unit 514 performs a communication process via a network including the Internet.

The input/output interface 510 is connected to a drive 515 as necessary, and a removable medium 521 such as a magnetic disk, an optical disc, a magneto-optical disc, or a semiconductor memory is appropriately attached to the input/output interface 510. A computer program read from these media is installed in the storage unit 513 as necessary.

When the above series of processes are executed by software, a program that constitutes the software is installed from a network or a recording medium.

As illustrated in FIG. 18, the recording medium may be configured as the removable medium 521 which is provided separately from an apparatus body and records therein a program which is distributed so as to deliver the program to the user, such as a magnetic disk (including a flexible disk), an optical disc (including a compact disc-read only memory (CD-ROM) and a digital versatile disc (DVD)), an magneto-optical disc (including a mini disc (MD)), or a semiconductor memory. The recording medium may be configured as the ROM 502 in which the program is recorded and which is delivered to the user in a state of being incorporated into the apparatus body in advance and a hard disk included in the storage unit 513.

The program executed by the computer may be a program that execute processes in a time-sequential manner in accordance with the procedures described in this specification and may be a program that executes the processes in a parallel manner or at necessary time such as in response to calls.

Moreover, in this specification, the steps that describe the program recorded in the recording medium include not only processes which are executed in time-sequential manner in accordance with the described procedures but also processes which are executed in parallel or separately even if it is not always executed in time-sequential manner.

In this specification, the term “system” is used to represent an apparatus as a whole, which includes a plurality of devices.

In the above description, the configuration described as one apparatus (or processor) may be split into a plurality of apparatuses (or processors). Alternatively, the configuration described as a plurality of apparatuses (or processors) may be integrated into a single apparatus (or processor). Moreover, a configuration other than those discussed above may be included in the above-described configuration of each apparatus (or each processor). If the configuration and the operation of a system as a whole is substantially the same, part of the configuration of an apparatus (or processor) may be added to the configuration of another apparatus (or another processor). The embodiments of the present disclosure are not limited to the above-described embodiments, but various modifications can be made in a range not departing from the gist of the present disclosure.

For example, the image encoding device and the image decoding device described above can be applied to an optional electronic apparatus. The examples thereof will be described below.

### 4. Fourth Embodiment

### [Television Receiver]

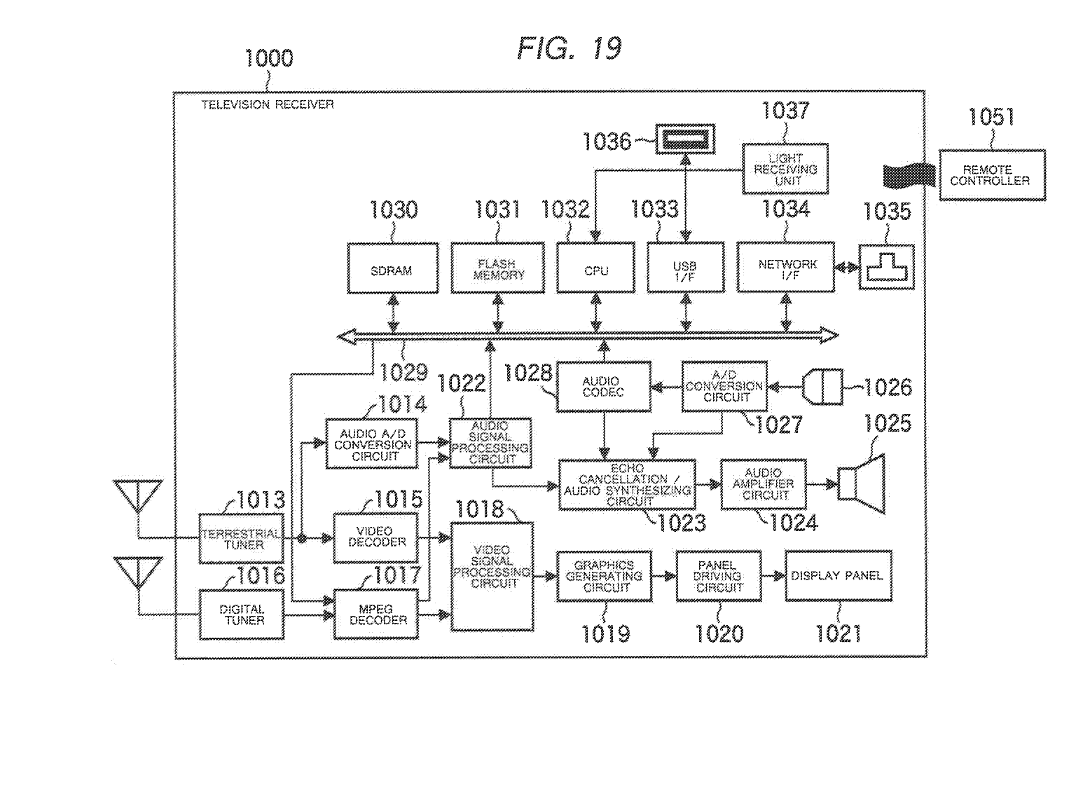

FIG. 19 is a block diagram illustrating a main configuration example of a television receiver that uses the image decoding device 200.

A television receiver 1000 illustrated in FIG. 19 includes a terrestrial tuner 1013, a video decoder 1015, a video signal processing circuit 1018, a graphics generating circuit 1019, a panel driving circuit 1020, and a display panel 1021.

The terrestrial tuner 1013 receives a broadcast wave signal of a terrestrial analog broadcast via an antenna, demodulates the broadcast wave signal to obtain a video signal, and supplies the video signal to the video decoder 1015. The video decoder 1015 performs a decoding process on the video signal supplied from the terrestrial tuner 1013 to obtain a digital component signal and supplies the obtained digital component signal to the video signal processing circuit 1018.

The video signal processing circuit 1018 performs a predetermined process such as a noise removal process on the video data supplied from the video decoder 1015 to obtain video data and supplies the obtained video data to the graphics generating circuit 1019.

The graphics generating circuit 1019 generates the video data of a program to be displayed on a display panel 1021, the image data obtained through the processing based on an application supplied via a network, and the like and supplies the generated video data or image data to the panel driving circuit 1020. Moreover, the graphics generating circuit 1019 also performs a process of generating video data (graphics) for displaying a screen used by the user for selecting an item or the like and supplying video data obtained by superimposing the video data on the video data of a program to the panel driving circuit 1020 as appropriate.

The panel driving circuit 1020 drives the display panel 1021 based on the data supplied from the graphics generating circuit 1019 and causes the display panel 1021 to display the video of a program and the above-described various screens.

The display panel 1021 is formed of a liquid crystal display (LCD) or the like, and displays the video of a program or the like in accordance with the control of the panel driving circuit 1020.

Moreover, the television receiver 1000 also includes an audio analog/digital (A/D) conversion circuit 1014, an audio signal processing circuit 1022, an echo cancellation/audio synthesizing circuit 1023, an audio amplifier circuit 1024, and a speaker 1025.

The terrestrial tuner 1013 demodulates the received broadcast wave signal to thereby obtain an audio signal as well as the video signal. The terrestrial tuner 1013 supplies the obtained audio signal to the audio A/D conversion circuit 1014.

The audio A/D conversion circuit 1014 performs an A/D conversion process on the audio signal supplied from the terrestrial tuner 1013 to obtain a digital audio signal and supplies the obtained digital audio signal to the audio signal processing circuit 1022.

The audio signal processing circuit 1022 performs a predetermined process such as a noise removal process on the audio data supplied from the audio A/D conversion circuit 1014 to obtain audio data and supplies the obtained audio data to the echo cancellation/audio synthesizing circuit 1023.

The echo cancellation/audio synthesizing circuit 1023 supplies the audio data supplied from the audio signal processing circuit 1022 to the audio amplifier circuit 1024.

The audio amplifier circuit 1024 performs a D/A conversion process and an amplification process on the audio data supplied from the echo cancellation/audio synthesizing circuit 1023 to adjust the volume of the audio data to a predetermined volume and then outputs the audio from the speaker 1025.

Further, the television receiver 1000 also includes a digital tuner 1016 and an MPEG decoder 1017.

The digital tuner 1016 receives the broadcast wave signal of a digital broadcast (terrestrial digital broadcast, BS (Broadcasting Satellite)/CS (Communications Satellite) digital broadcast) via the antenna, demodulates the broadcast wave signal to obtain an MPEG-TS (Moving Picture Experts Group-Transport Stream) and supplies the MPEG-TS to the MPEG decoder 1017.

The MPEG decoder 1017 descrambles the scrambling given to the MPEG-TS supplied from the digital tuner 1016 and extracts a stream including the data of a program serving as a reproduction object (viewing object). The MPEG decoder 1017 decodes an audio packet that constitutes the extracted stream to obtain audio data, supplies the obtained audio data to the audio signal processing circuit 1022, decodes a video packet that constitutes the stream to obtain video data, and supplies the obtained video data to the video signal processing circuit 1018. Moreover, the MPEG decoder 1017 supplies electronic program guide (EPG) data extracted from the MPEG-TS to a CPU 1032 via a path (not illustrated).

The television receiver 1000 uses the above-described image decoding device 200 as the MPEG decoder 1017 that decodes video packets in this way. The MPEG-TS transmitted from a broadcasting station or the like is encoded by the image encoding device 100.

Similarly to the case of the image decoding device 200, the MPEG decoder 1017 corrects the quantization parameter for the luminance signal using the offset information chrominance_qp_index_offset_extmb during the dequantization process for the chrominance signal of the extended macroblock to thereby generate the quantization parameter appropriate for the chrominance signal of the extended macroblock and performs dequantization using the quantization parameter. Thus, the MPEG decoder 1017 can dequantize the orthogonal transform coefficient quantized by the image encoding device 100 appropriately. In this way, the MPEG decoder 1017 can suppress image quality deterioration such as blurring of colors, which occurs in the chrominance signal due to an error of the motion information during the motion prediction and compensation process while suppressing a decrease of the coding efficiency.

Similarly to the case of the video data supplied from the video decoder 1015, the video data supplied from the MPEG decoder 1017 is subjected to a predetermined process in the video signal processing circuit 1018. Then, the generated video data and the like is appropriately superimposed on the video data supplied from the MPEG decoder 1017 in the graphics generating circuit 1019, the superimposed video data is supplied to the display panel 1021 via the panel driving circuit 1020, and the image thereof is displayed.

The audio data supplied from the MPEG decoder 1017 is, in the same way as with the case of the audio data supplied from the audio A/D conversion circuit 1014, subjected to predetermined processing in the audio signal processing circuit 1022. The audio data having been subjected to predetermined processing is then supplied to the audio amplifier circuit 1024 via the echo cancellation/audio synthesizing circuit 1023 and is subjected to D/A conversion processing and amplifier processing. As a result, the audio of which the volume is adjusted to a predetermined volume is output from the speaker 1025.

Moreover, the television receiver 1000 also includes a microphone 1026 and an A/D conversion circuit 1027

The A/D conversion circuit 1027 receives the audio signal of the user collected by the microphone 1026 provided to the television receiver 1101 for the purpose of audio conversation, performs an A/D conversion process on the received audio signal to obtain digital audio data, and supplies the obtained digital audio data to the echo cancellation/audio synthesizing circuit 1023.

When the audio data of the user (user A) of the television receiver 1000 has been supplied from the A/D conversion circuit 1027, the echo cancellation/audio synthesizing circuit 1023 perform echo cancellation on the audio data of the user A taken as a object and outputs audio data obtained by synthesizing the audio data with other audio data and the like from the speaker 1025 via the audio amplifier circuit 1024.

Further, the television receiver 1000 also includes an audio codec 1028, an internal bus 1029, a synchronous dynamic random access memory (SDRAM) 1030, a flash memory 1031, a CPU 1032, a universal serial bus (USB) I/F 1033, and a network I/F 1034.

The A/D conversion circuit 1027 receives the audio signal of the user collected by the microphone 1026 provided to the television receiver 1000 for the purpose of audio conversation, performs an A/D conversion process on the received audio signal to obtain digital audio data, and supplies the obtained digital audio data to the audio codec 1028.

The audio codec 1028 converts the audio data supplied from the A/D conversion circuit 1027 into the data of a predetermined format for transmission via a network and supplies the converted audio data to the network I/F 1034 via the internal bus 1029.

The network I/F 1034 is connected to the network via a cable attached to a network terminal 1035. The network I/F 1034 transmits the audio data supplied from the audio codec 1028 to another device connected to the network thereof, for example. Moreover, the network I/F 1034 receives the audio data transmitted from another device connected thereto via a network for example via the network terminal 1035 and supplies the audio data to the audio codec 1028 via the internal bus 1029.

The audio codec 1028 converts the audio data supplied from the network I/F 1034 into the data of a predetermined format and supplies the converted audio data to the echo cancellation/audio synthesizing circuit 1023.

The echo cancellation/audio synthesizing circuit 1023 performs echo cancellation on the audio data supplied from the audio codec 1028 taken as a object and outputs the audio data obtained by synthesizing the audio data with other audio data and the like from the speaker 1025 via the audio amplifier circuit 1024.

The SDRAM 1030 stores various types of data necessary for the CPU 1032 to perform processing.

The flash memory 1031 stores a program to be executed by the CPU 1032. The program stored in the flash memory 1031 is read by the CPU 1032 at predetermined timing such as when the television receiver 1000 is started. The EPG data obtained via a digital broadcast, data obtained from a predetermined server via a network, and the like are also stored in the flash memory 1031.

For example, MPEG-TS that includes the content data obtained from a predetermined server via a network according to the control of the CPU 1032 is stored in the flash memory 1031. The flash memory 1031 supplies the MPEG-'TS to the MPEG decoder 1017 via the internal bus 1029 according to the control of the CPU 1032, for example.

The MPEG decoder 1017 processes the MPEG-TS in a manner similarly to the case of the MPEG-TS supplied from the digital tuner 1016. In this way, the television receiver 1000 receives the content data made up of video, audio, and the like via a network and decodes the content data using the MPEG decoder 1017, whereby the video can be displayed and the audio can be output.

Moreover, the television receiver 1000 also includes a light receiving unit 1037 that receives the infrared signal transmitted from a remote controller 1051.

The light receiving unit 1037 receives infrared rays from the remote controller 1051, decodes the infrared rays to obtain a control code that indicates the content of the user's operation, and outputs the control code to the CPU 1032.

The CPU 1032 executes the program stored in the flash memory 1031 and controls the operation of the entire television receiver 1000 according to the control, code or the like supplied from the light receiving unit 1037. The CPU 1032 and the respective units of the television receiver 1000 are connected via a path (not illustrated).

The USB I/F 1033 transmits and receives data to and from an external device of the television receiver 1000, which is connected via a USB cable attached to a USB terminal 1036. The network I/F 1034 is connected to a network via a cable attached to the network terminal 1035 and also transmits and receives data other than audio data to and from various devices connected to the network.

Since the television receiver 1000 uses the image decoding device 200 as the MPEG decoder 1017, it is possible to suppress image quality deterioration while suppressing a decrease of the coding efficiency of the broadcast wave signal received via an antenna and the content data acquired via a network.

### 5. Fifth Embodiment

### [Cellular Phone]

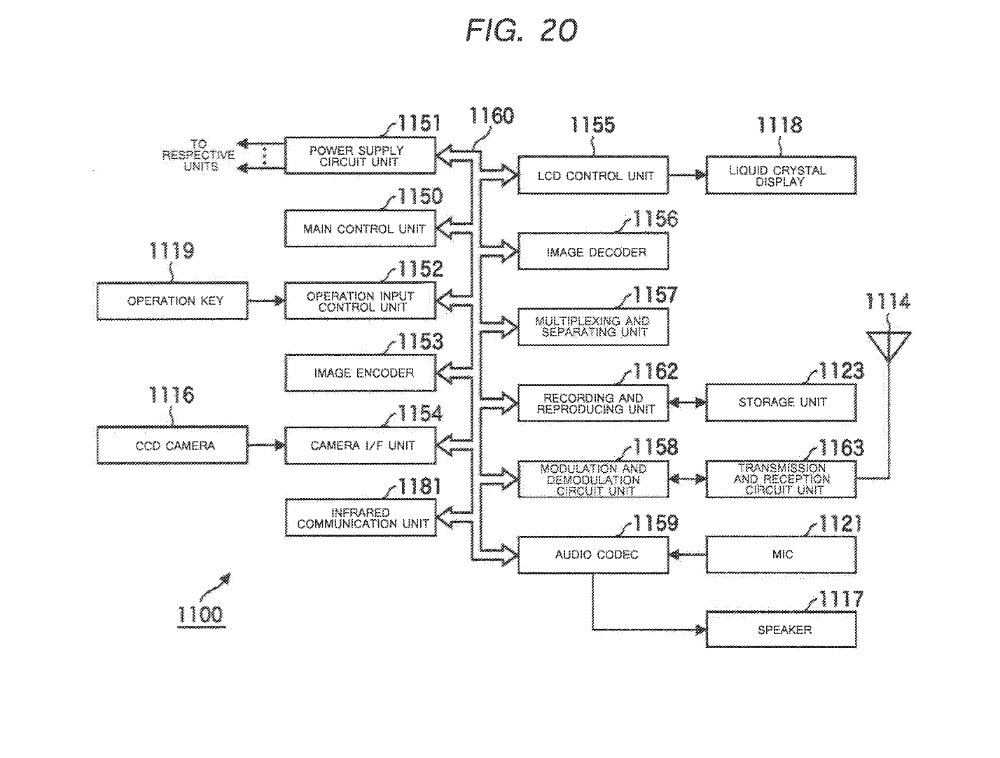

FIG. 20 is a block diagram illustrating a main configuration example of a cellular phone that uses the image encoding device 100 and the image decoding device 200.

A cellular phone 1100 illustrated in FIG. 20 includes a main control unit 1150 configured to integrally control the respective units, a power supply circuit unit 1151, an operation input control unit 1152, an image encoder 1153, a camera I/F unit 1154, an LCD control unit 1155, an image decoder 1156, a multiplexing and separating unit 1157, a recording and reproducing unit 1162, a modulation and demodulation circuit unit 1158, and an audio codec 1159. These units are connected to each other via a bus 1160.

Moreover, the cellular phone 1100 includes operation keys 1119, a charge coupled devices (CCD) camera 1116, a liquid crystal display 1118, a storage unit 1123, a transmission and reception circuit unit 1163, an antenna 1114, a microphone (MIC) 1121, and a speaker 1117.

When a call is ended and a power key is turned on by the user's operation, the power supply circuit unit 1151 activates the cellular phone 1100 to an operable state by supplying power to the respective units from a battery pack.

The cellular phone 1100 performs various operations such as transmission and reception of an audio signal, transmission and reception of an e-mail and image data, image shooting, or data recording in various modes such as a voice call mode and a data communication mode based on the control of a main control unit 1150 which includes a CPU, ROM, RAM, and the like.

For example, in the voice call mode, the cellular phone 1100 converts the audio signal collected by the microphone (MIC) 1121 into digital audio data by the audio codec 1159, subjects the digital audio data to spectrum spread processing in the modulation and demodulation circuit unit 1158, and subjects the digital audio data to digital-to-analog conversion processing and frequency conversion processing in the transmission and reception circuit unit 1163. The cellular phone 1100 transmits a transmission signal obtained by the conversion processing to a base station (not illustrated) via the antenna 1114. The transmission signal (audio signal) transmitted to the base station is supplied to a cellular phone of a communication counterpart via a public telephone network.

Moreover, for example, in the voice call mode, the cellular phone 1100 amplifies the reception signal received by the antenna 1114 with the aid of the transmission and reception circuit unit 1163, subjects the amplified reception signal to frequency conversion processing and analog-to-digital conversion processing, subjects the same to inverse spectrum spread processing in the modulation and demodulation circuit unit 1158, and converts the processed audio signal into an analog audio signal with the aid of the audio codec 1159. The cellular phone 1100 outputs the analog audio signal obtained by the conversion from the speaker 1117.

Further, for example, when transmitting an e-mail in the data communication mode, the operation input control unit 1152 of the cellular phone 1100 accepts the text data of an e-mail input by the operation of the operation keys 1119. The cellular phone 1100 processes the text data with the aid of the main control unit 1150 and displays the text data on the liquid crystal display 1118 as an image with the aid of the LCD control unit 1155.

Moreover, the main control unit 1150 of the cellular phone 1100 generates e-mail data based on the text data, the user's instructions, and the like accepted by the operation input control unit 1152. The cellular phone 1100 subjects the e-mail data to spectrum spread processing in the modulation and demodulation circuit unit 1158 and subjects the e-mail data to digital-to-analog conversion processing and frequency conversion processing in the transmission and reception circuit unit 1163.

The cellular phone 1100 transmits the transmission signal obtained by the conversion processing to a base station (not illustrated) via the antenna 1114. The transmission signal (e-mail) transmitted to the base station is supplied to a predetermined destination via a network, a mail server, and the like.

Moreover, for example, when receiving an e-mail in the data communication mode, the cellular phone 1100 receives the signal transmitted from the base station via the antenna 1114 with the aid of the transmission and reception circuit unit 1163, amplifies the signal, and subjects the signal to frequency conversion processing and analog-to-digital conversion processing. The cellular phone 1100 subjects the reception signal to inverse spectrum spread processing in the modulation and demodulation circuit unit 1158 to reconstruct the original e-mail data. The cellular phone 1100 displays the reconstructed e-mail data on the liquid crystal display 1118 with the aid of the LCD control unit 1155.

The cellular phone 1100 may record (store) the received e-mail data in the storage unit 1123 via the recording and reproducing unit 1162.

This storage unit 1123 is an optional rewritable storage medium. The storage unit 1123 may be, for example, a semiconductor memory such as a RAM or a built-in flash memory, may be a hard disk, or may be a removable medium such as a magnetic disk, a magneto-optical disc, or an optical disc, a USB memory, a memory card. Naturally, the storage unit 1123 may be other than the above.

Further, for example, when transmitting image data in the data communication mode, the cellular phone 1100 generates image data by imaging with the aid of the COD camera 1116. The CCD camera 1116 includes a COD serving as an optical device such as a lens or diaphragm and serving as a photoelectric device, which images a subject, converts the intensity of received light, into an electrical signal, and generates the image data of the subject image. The COD camera 1116 encodes the image data using the image encoder 1153 with the aid of the camera I/F unit 1154 to convert the image data into encoded image data.

The cellular phone 1100 uses the above-described image encoding device 100 as the image encoder 1153 that performs such a process. Similarly to the case of the image encoding device 100, the image encoder 1153 corrects the quantization parameter for the luminance signal using the offset information chrominance_qp_index_offset_extmb during the quantization process for the chrominance signal of the extended macroblock to generate the quantization parameter appropriate for the chrominance signal of the extended macroblock and performs quantization using the quantization parameter. That is, the image encoder 1153 can improve the degree of freedom of setting the quantization parameter for the chrominance signal of the extended macroblock. In this way, the image encoder 1153 can suppress image quality deterioration such as blurring of colors, which occurs in the chrominance signal due to an error of the motion information during the motion prediction and compensation process while suppressing a decrease of the coding efficiency.

At the same time, the cellular phone 1100 performs analog-to-digital conversion on the audio collected by the microphone (MIC) 1121 during imaging by the COD camera 1116 with the aid of the audio codec 1159 and encodes the audio.

The multiplexing and separating unit 1157 of the cellular phone 1100 multiplexes the encoded image data supplied from the image encoder 1153 and the digital audio data supplied from the audio codec 1159 according to a predetermined scheme. The cellular phone 1100 subjects the multiplexed data obtained as a result thereof to spectrum spread processing in the modulation and demodulation circuit unit 1158 and subjects the same to digital-to-analog conversion processing and frequency conversion processing in the transmission and reception circuit unit 1163. The cellular phone 1100 transmits the transmission signal obtained by the conversion processing to a base station (not illustrated) via the antenna 1114. The transmission signal (image data) transmitted to the base station is supplied to a communication counterpart via a network or the like.

When image data is not transmitted, the cellular phone 1100 may display the image data generated by the COD camera 1116 on the liquid crystal display 1118 via the LCD control unit 1155 instead of the image encoder 1153.

Moreover, for example, when receiving the data of a moving image file linked to a simple website or the like in the data communication mode, the cellular phone 1100 receives the signal transmitted from the base station with the aid of the transmission and reception circuit unit 1163 via the antenna 1114, amplifies the signal, and subjects the signal to frequency conversion processing and analog-to-digital conversion processing. The cellular phone 1100 subjects the received signal to inverse spectrum spread processing in the modulation and demodulation circuit unit 1158 to reconstruct the original multiplexed data. The multiplexing and separating unit 1157 of the cellular phone 1100 separates the multiplexed data into encoded image data and audio data.

The image decoder 1156 of the cellular phone 1100 decodes the encoded image data to generate reproduction moving image data and displays the moving image data on the liquid crystal display 1118 via the LCD control unit 1155. In this way, the moving image data included in the moving image file linked to the simple website, for example, is displayed on the liquid crystal display 1118.

The cellular phone 1100 uses the above-described image decoding device 200 as the image decoder 1156 that performs such a process. That is, similarly to the case of the image decoding device 200, the image decoder 1136 corrects the quantization parameter for the luminance signal using the offset information chrominance_qp_index_offset_extmb during the dequantization process for the chrominance signal of the extended macroblock to thereby generate the quantization parameter appropriate for the chrominance signal of the extended macroblock and performs dequantization using the quantization parameter. Thus, the image decoder 1156 can dequantize the orthogonal transform coefficient quantized by the image encoding device 100 appropriately. In this way, the image decoder 1156 can suppress image quality deterioration such as blurring of colors, which occurs in the chrominance signal due to an error of the motion information during the motion prediction and compensation process while suppressing a decrease of the coding efficiency.

At the same time, the audio codec 1159 of the cellular phone 1100 converts the digital audio data into an analog audio signal and outputs the analog audio signal from the speaker 1117. In this way, audio data included in the moving image file linked to a simple website, for example, is reproduced.

Similarly to the case of the e-mail, the cellular phone 1100 may record (store) the received data linked to a simple website or the like in the storage unit 1123 via the recording and reproducing unit 1162.

Moreover, the main control unit 1150 of the cellular phone 1100 can analyze a two-dimensional code obtained by being imaged by the CCD camera 1116 to obtain information recorded in the two-dimensional code.

Further, the cellular phone 1100 can communicate with an external device via infrared rays with the aid of the infrared communication unit 1181.

Since the cellular phone 1100 uses the image encoding device 100 as the image encoder 1153, it is possible to suppress image quality deterioration while suppressing a decrease of the coding efficiency of the encoded data when the image data generated by the COD camera 1116, for example, is encoded and transmitted.

Moreover, since the cellular phone 1100 uses the image decoding device 200 as the image decoder 1156, it is possible to suppress image quality deterioration while suppressing a decrease of the coding efficiency of the data (encoded data) of a moving image file linked to a simple website or the like, for example.

In the above description, although the cellular phone 1100 uses the CCD camera 1116, the cellular phone 1100 may use an image sensor (CMOS image sensor) that uses CMOS (Complementary Metal Oxide Semiconductor) instead of the COD camera 1116. In this case, the cellular phone 1100 can image a subject and generate the image data of the subject image in a manner similarly to the case of using the COD camera 1116.

Moreover, in the above description, although the cellular phone 1100 has been described, the image encoding device 100 and the image decoding device 200 may be applied to any device such as, for example, a FDA (Personal Digital Assistants), a smart phone, UMPC (Ultra Mobile Personal Computers), and a net-book, a notebook-type personal computer in a manner similarly to the case of the cellular phone 1100 as long as the device has the same imaging function and communication function as those of the cellular phone 1100.

### 6. Sixth Embodiment

### [Hard Disk Recorder]

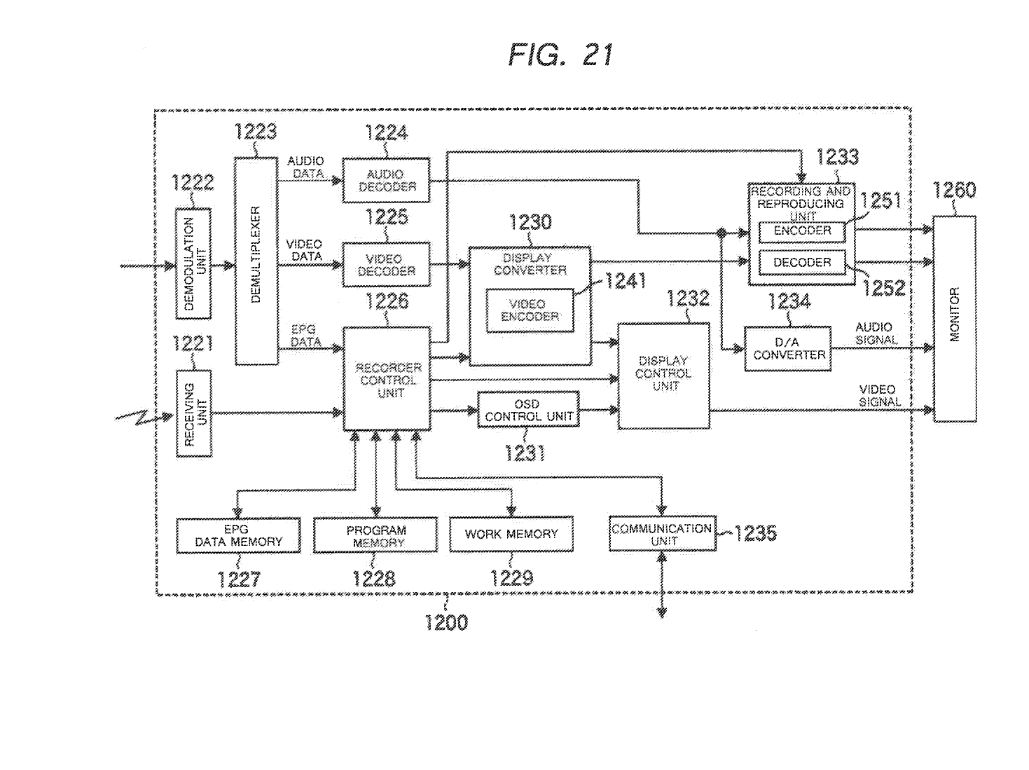

FIG. 21 is a block diagram illustrating a main configuration example of a hard disk recorder that uses the image encoding device 100 and the image decoding device 200.

A hard disk recorder (HDD recorder) 1200 illustrated in FIG. 21 is a device that stores audio data and video data of a broadcast program which is included in a broadcast wave signal (television signal) received by a tuner and transmitted from a satellite or terrestrial antenna or the like in a built-in hard disk and provides the stored data to the user at a timing according to the user's instructions.

The hard disk recorder 1200 can extract audio data and video data from the broadcast wave signal, for example, decode the data appropriately, and store the data in the built-in hard disk. Moreover, the hard disk recorder 1200 can also acquire audio data and video data from another device via a network, for example, decode the data appropriately, and store the data in the built-in hard disk.

Further, the hard disk recorder 1200 can decode audio data and video data recorded in the built-in hard disk, supply the data to a monitor 1260, display the image thereof on the screen of the monitor 1260, and output the sound thereof from the speaker of the monitor 1260. Moreover, the hard disk recorder 1200 can decode audio data and video data extracted from the broadcast wave signal obtained via a tuner, for example, or the audio data and video data obtained from another device via a network, supply the data to the monitor 1260, display the image thereof on the screen of the monitor 1260, and output the sound thereof from the speaker of the monitor 1260.

Naturally, operations other than the above may be performed.

As illustrated in FIG. 21, the hard disk recorder 1200 includes a receiving unit 1221, a demodulation unit 1222, a demultiplexer 1223, an audio decoder 1224, a video decoder 1225, and a recorder control unit 1226. The hard disk recorder 1200 further includes an EPG data memory 1227, a program memory 1228, a work memory 1229, a display converter 1230, an OSD (On Screen Display) control unit 1231, a display control unit 1232, a recording and reproducing unit 1233, a D/A converter 1234, and a communication unit 1235.

Moreover, the display converter 1230 includes a video encoder 1241. The recording and reproducing unit 1233 includes an encoder 1251 and a decoder 1252.

The receiving unit 1221 receives the infrared signal from a remote controller (not illustrated) converts the signal into an electrical signal, and outputs the signal to the recorder control unit 1226. The recorder control unit 1226 is configured of, for example, a microprocessor or the like, and executes various types of processing in accordance with the program stored in the program memory 1228. At this time, the recorder control unit 1226 uses the work memory 1229 as necessary.

The communication unit 1235 is connected to the network, and performs communication processing with another device via the network. For example, the communication unit 1235 is controlled by the recorder control unit 1226, communicates with a tuner (not illustrated), and outputs a channel selection control signal mainly to the tuner.

The demodulation unit 1222 demodulates the signal supplied from the tuner and outputs the demodulated signal to the demultiplexer 1223. The demultiplexer 1223 separates the data supplied from the demodulation unit 1222 into audio data, video data, and EPG data and outputs the respective items of data to the audio decoder 1224, the video decoder 1225, and the recorder control unit 1226, respectively.

The audio decoder 1224 decodes the input audio data and outputs the decoded data to the recording and reproducing unit 1233. The video decoder 1225 decodes the input video data and outputs the decoded data to the display converter 1230. The recorder control unit 1226 supplies the input EPG data to the EPG data memory 1227, which stores the EPG data.

The display converter 1230 encodes the video data supplied from the video decoder 1225 or the recorder control unit 1226 into the video data conforming to the NTSC (National Television Standards Committee) format, for example, using the video encoder 1241 and outputs the video data to the recording and reproducing unit 1233. Moreover, the display converter 1230 converts the size of the screen of the video data supplied from the video decoder 1225 or the recorder control unit 1226 into the size corresponding to the size of the monitor 1260. The display converter 1230 converts the video data into video data conforming to the NTSC format using the video encoder 1241, converts the video data into an analog signal, and outputs the analog signal to the display control unit 1232.

The display control unit 1232 superimposes the OSD signal output from the OSD (On Screen Display) control unit 1231 on the video signal input from the display converter 1230 under the control of the recorder control unit 1226 and outputs the video signal to the display of the monitor 1260, which displays the video signal.

Moreover, the audio data output from the audio decoder 1224 is converted into an analog signal by the D/A converter 1234 and is supplied to the monitor 1260. The monitor 1260 outputs the audio signal from a built-in speaker.

The recording and reproducing unit 1233 includes a hard disk as a storage medium in which video data, audio data, and the like are recorded.

The recording and reproducing unit 1233 encodes the audio data supplied from the audio decoder 1224 with the aid of the encoder 1251, for example. Moreover, the recording and reproducing unit 1233 encodes the video data supplied from the video encoder 1241 of the display converter 1230 with the aid of the encoder 1251. The recording and reproducing unit 1233 synthesizes the encoded data of the audio data and the encoded data of the video data with the aid of the multiplexer. The recording and reproducing unit 1233 amplifies the synthesized data by channel coding and writes the data in a hard disk with the aid of a recording head.

The recording and reproducing unit 1233 reproduces the data recorded in the hard disk with the aid of a reproducing head, amplifies the data, and separates the data into audio data and video data with the aid of the demultiplexer. The recording and reproducing unit 1233 decodes the audio data and video data with the aid of the decoder 1252. The recording and reproducing unit 1233 performs D/A conversion on the decoded audio data and outputs the data to the speaker of the monitor 1260. Moreover, the recording and reproducing unit 1233 performs D/A conversion on the decoded video data and outputs the data to the display of the monitor 1260.

The recorder control unit 1226 reads the latest EPG data from the EPG data memory 1227 based on the user's instructions indicated by the infrared signal from the remote controller which is received via the receiving unit 1221 and supplies the EPG data to the OSD control unit 1231. The OSD control unit 1231 generates image data corresponding to the input EPG data and outputs the image data to the display control unit 1232. The display control unit 1232 outputs the video data input from the OSD control unit 1231 to the display of the monitor 1260, which displays the video data. In this way, the EPG (Electronic Program Guide) is displayed on the display of the monitor 1260.

Moreover, the hard disk recorder 1200 can obtain various types of data such as video data, audio data, or EPG data supplied from another device via the network such as the Internet.

The communication unit 1235 is controlled by the recorder control unit 1226, obtains encoded data such as video data, audio data, EPG data, and the like transmitted from another device via the network, and supplies the encoded data to the recorder control unit 1226. The recorder control unit 1226 supplies the encoded data of the obtained video data and audio data to the recording and reproducing unit 1233 and stores the encoded data in the hard disk, for example. At this time, the recorder control unit 1226 and the recording and reproducing unit 1233 may perform processing such as re-encoding or the like as necessary.

Moreover, the recorder control unit 1226 decodes the encoded data of the obtained video data and audio data to obtain video data and supplies the obtained video data to the display converter 1230.

Similarly to the video data supplied from the video decoder 1225, the display converter 1230 processes the video data supplied from the recorder control unit 1226, supplies the video data to the monitor 1260 via the display control unit 1232, and displays the image thereof.

Moreover, the recorder control unit 1226 may supply the decoded audio data to the monitor 1260 via the D/A converter 1234 and output the sound thereof from the speaker in synchronization with the display of the image.

Further, the recorder control unit 1226 decodes the encoded data of the obtained EPG data and supplies the decoded. EPG data to the EPG data memory 1227.

The hard disk recorder 1200 having such a configuration uses the image decoding device 200 as the video decoder 1225, the decoder 1252, and a decoder included in the recorder control unit 1226. That is, similarly to the case of the image decoding device 200, the video decoder 1225, the decoder 1252, and the decoder included in the recorder control unit 1226 correct the quantization parameter for the luminance signal using the offset information chrominance_qp_index_offset_extmb during the dequantization process for the chrominance signal of the extended macroblock to generate the quantization parameter appropriate for the chrominance signal of the extended macroblock and perform dequantization using the quantization parameter. Thus, the video decoder 1225, the decoder 1252, and the decoder included in the recorder control unit 1226 can dequantize the orthogonal transform coefficient quantized by the image encoding device 100 appropriately. In this way, the video decoder 1225, the decoder 1252, and the decoder included in the recorder control unit 1226 can suppress image quality deterioration such as blurring of colors, which occurs in the chrominance signal due to an error of the motion information during the motion prediction and compensation process while suppressing a decrease of the coding efficiency.

Accordingly, the hard disk recorder 1200 can suppress image quality deterioration while suppressing a decrease of the coding efficiency of the video data (encoded data) received by the tuner and the communication unit 1235 and the video data (encoded data) reproduced by the recording and reproducing unit 1233, for example.

Moreover, the hard disk recorder 1200 uses the image encoding device 100 as the encoder 1251. Thus, similarly to the case of the image encoding device 100, the encoder 1251 corrects the quantization parameter for the luminance signal using the offset information chrominance_qp_index_offset_extmb during the quantization process for the chrominance signal of the extended macroblock to generate the quantization parameter appropriate for the chrominance signal of the extended macroblock and performs quantization using the quantization parameter. That is, the encoder 1251 can improve the degree of freedom of setting the quantization parameter for the chrominance signal of the extended macroblock. In this way, the encoder 1251 can suppress image quality deterioration such as blurring of colors, which occurs in the chrominance signal due to an error of the motion information during the motion prediction and compensation process while suppressing a decrease of the coding efficiency.

Therefore, the hard disk recorder 1200 can suppress image quality deterioration while suppressing a decrease of the coding efficiency of the encoded data which is recorded on a hard disk, for example.

In the above description, although the hard disk recorder 1200 that records video data and audio data in the hard disk has been described, naturally, an optional recording medium may be used. For example, the image encoding device 100 and the image decoding device 200 can be applied to a recorder which uses a recording medium other than the hard disk, such as a flash memory, an optical disc, or a video tape in a manner similarly to the case of the above-described hard disk recorder 1200.

### 7. Seventh Embodiment

### [Camera]

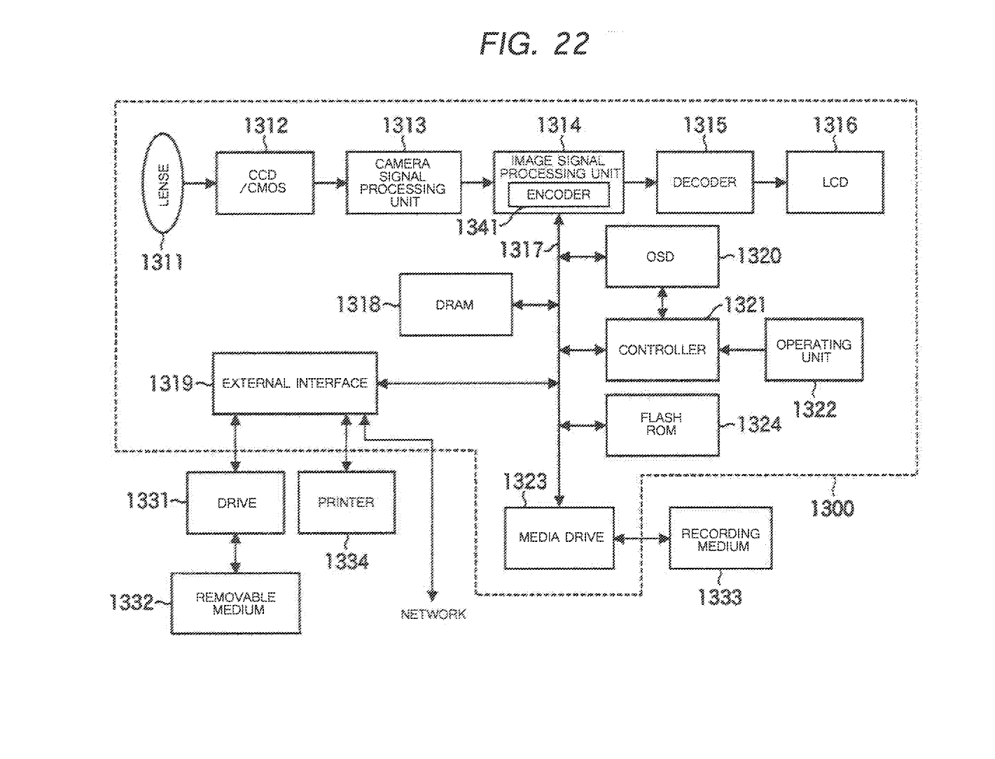

FIG. 22 is a block diagram illustrating a main configuration example of a camera that uses the image encoding device 100 and the image decoding device 200.

A camera 1300 illustrated in FIG. 22 images a subject, displays the subject image on an LCD 1316, and records the subject image in a recording medium 1333 as image data.

A lens block 1311 inputs light (that is, video of a subject) to a COD/CMOS 1312. The COD/CMOS 1312 is an image sensor that uses a COD or a CMOS, converts the intensity of received light into an electrical signal, and supplies the electrical signal to a camera signal processing unit 1313.

The camera signal processing unit 1313 converts the electrical signal supplied from the COD/CMOS 1312 into chrominance signals of Y, Cr, and Cb, and supplies the chrominance signals to an image signal processing unit 1314. The image signal processing unit 1314 subjects the image signal supplied from the camera signal processing unit 1313 to predetermined image processing under the control of a controller 1321 and encodes the image signal using an encoder 1341. The image signal processing unit 1314 encodes the image signal to generate encoded data and supplies the encoded data to a decoder 1315. Further, the image signal processing unit 1314 obtains display data generated by an onscreen display (OSD) 1320 and supplies the display data to the decoder 1315.

In the above-described processing, the camera signal processing unit 1313 stores image data, the encoded image data, and the like in the DRAM 1318 as necessary by appropriately using a DRAM (Dynamic Random Access Memory) 1318 connected via a bus 1317.

The decoder 1315 decodes the encoded data supplied from the image signal processing unit 1314 to obtain image data (decoded image data) and supplies the image data to the LCD 1316. Moreover, the decoder 1315 supplies the display data supplied from the image signal processing unit 1314 to the LCD 1316. The LCD 1316 synthesizes the image of the decoded image data supplied from the decoder 1315 with the image of the display data appropriately and displays a synthesized image thereof.

The onscreen display 1320 outputs display data such as a menu screen or icons made up of symbols, characters, or graphics to the image signal processing unit 1314 via the bus 1317 under the control of the controller 1321.

Based on a signal that indicates the content of a command input by the user using an operating unit 1322, the controller 1321 executes various types of processing and controls the image signal processing unit 1314, the DRAM 1318, the external interface 1319, the on-screen display 1320, the media drive 1323, and the like via the bus 1317. A program, data, and the like necessary for the controller 1321 to execute various types of processing are stored in FLASH ROM 1324.

For example, the controller 1321 can encode image data stored in the DRAM 1318 or decode encoded data stored in the DRAM 1318 instead of the image signal processing unit 1314 and the decoder 1315. At this time, the controller 1321 may perform encoding and decoding processing according to the same scheme as the encoding and decoding scheme of the image signal processing unit 1314 and the decoder 1315 and may perform encoding and decoding processing according to a scheme that does not correspond to the encoding and decoding scheme of the image signal processing unit 1314 or the decoder 1315.

Moreover, for example, when an instruction to start printing an image is received from the operating unit 1322, the controller 1321 reads image data from the DRAM 1318 and supplies the image data to a printer 1334 connected to the external interface 1319 via the bus 1317 so that the image data is printed.

Further, for example, when an instruction to record an image is received from the operating unit 1322, the controller 1321 reads encoded data from the DRAM 1318 and supplies the encoded data to a recording medium 1333 loaded on the media drive 1323 via the bus 1317 so that the encoded data is stored in the recording medium 1333.

The recording medium 1333 is an optional readable/writable removable medium, such as, for example, a magnetic disc, a magneto-optical disc, an optical disc, or a semiconductor memory. Naturally, the type of the removable medium is optional, and the recording medium 1333 may be a tape device, a disc, or a memory card. Naturally, the recording medium 1333 may be a non-contact IC card or the like.

Moreover, the media drive 1323 and the recording medium 1333 may be integrated as, for example, a non-portable recording medium such as a built-in hard disk drive or an SSD (Solid State Drive).

The external interface 1319 is configured of, for example, a USB input/output terminal and is connected to the printer 1334 when performing printing of images. Moreover, a drive 1331 is connected to the external interface 1319 as necessary, and the removable medium 1332 such as a magnetic disk, an optical disc, or a magneto-optical disc is loaded on the drive 1331 appropriately. A computer program read from these removable media is installed in the FLASH ROM 1324 as necessary.

Further, the external interface 1319 includes a network interface connected to a predetermined network such as a LAN or the Internet For example, in accordance with the instructions from the operating unit 1322, the controller 1321 can read encoded data from the DRAM 1318 and supply the encoded data from the external interface 1319 to another device connected via the network. Moreover, the controller 1321 can obtain encoded data and image data supplied from another device via the network via the external interface 1319, store the data in the DRAM 1318, and supply the data to the image signal processing unit 1314.

The camera 1300 having such a configuration uses the image decoding device 200 as the decoder 1315. That is, similarly to the case of the image decoding device 200, the decoder 1315 corrects the quantization parameter for the luminance signal using the offset information chrominance_qp_index_offset_extmb during the dequantization process for the chrominance signal of the extended macroblock to thereby generate the quantization parameter appropriate for the chrominance signal of the extended macroblock and performs dequantization using the quantization parameter. Thus, the decoder 1315 can dequantize the orthogonal transform coefficient quantized by the image encoding device 100 appropriately, in this way, the decoder 1315 can suppress image quality deterioration such as blurring of colors, which occurs in the chrominance signal due to an error of the motion information during the motion prediction and compensation process while suppressing a decrease of the coding efficiency.

Therefore, the camera 1300 can suppress image quality deterioration while suppressing a decrease of the coding efficiency of the image data generated by the CCD/CMOS 1312, the encoded data of the video data read from the DRAM 1318 or the recording medium 1333, and the encoded data of the video data acquired via network, for example.

Moreover, the camera 1300 uses the image encoding device 100 as the encoder 1341. Similarly to the case of the image encoding device 100, the encoder 1341 corrects the quantization parameter for the luminance signal using the offset information chrominance_qp_index_offset_extmb during the quantization process for the chrominance signal of the extended macroblock to generate the quantization parameter appropriate for the chrominance signal of the extended macroblock and performs quantization using the quantization parameter. That is, the encoder 1341 can improve the degree of freedom of setting the quantization parameter for the chrominance signal of the extended macroblock. In this way, the encoder 1341 can suppress image quality deterioration such as blurring of colors, which occurs in the chrominance signal due to an error of the motion information during the motion prediction and compensation process while suppressing a decrease of the coding efficiency.

Therefore, the camera 1300 can suppress image quality deterioration while suppressing a decrease of the coding efficiency of the encoded data recorded on the DRAM 1318 and the recording medium 1333 and the encoded data provided to another device, for example.

The decoding method of the image decoding device 200 may be applied to the decoding process performed by the controller 1321. Similarly, the encoding method of the image encoding device 100 may be applied to the encoding process performed by the controller 1321.

Moreover, the image data captured by the camera 1300 may be a moving image and may be a still image.

Naturally, the image encoding device 100 and the image decoding device 200 may be applied to a device or a system other than the above-described devices.

The present disclosure can be applied to, for example, an image encoding device and an image decoding device that are used when image information (a bit stream) which has been compressed by orthogonal transform such as discrete cosine transform and motion compensation as in the case of MPEG, H.26×, and the like is received via a network medium such as satellite broadcasting, a cable TV, the Internet, or a cellular phone, or is processed on a storage medium such as an optical or magnetic disk, or a flash memory.

The present disclosure may be embodied in the following configuration.

(1) An image processing device including a correction unit that corrects the relation between a quantization parameter for a luminance component of image data and a quantization parameter for a chrominance component of the image data using an extended area offset value which is an offset value to be applied to a quantization process of an area that is larger than a predetermined size within an image of the image data; a quantization parameter generating unit that generates the quantization parameter for the chrominance component of the area that is larger than the predetermined size from the quantization parameter for the luminance component based on the relation corrected by the correction unit; and a quantization unit that quantizes the data of the area using the quantization parameter generated by the quantization parameter generating unit.

(2) The image processing device according to (1), wherein the extended area offset value is a parameter different from a normal area offset value which is an offset value applied to a quantization process for the chrominance component, and the correction unit corrects the relation with respect to the quantization process for the chrominance component of the area having the predetermined size or smaller using the normal area offset value.

(3) The image processing device according to (2), further including a setting unit that sets the extended area offset value.

(4) The image processing device according to (3), wherein the setting unit sets the extended area offset value to be equal to or greater than the normal area offset value.

(5) The image processing device according to (3) or (4), wherein the setting unit sets the extended area offset value for each of a Cb component and a Cr component of the chrominance component, and the quantization parameter generating unit generates the quantization parameters for the Cb component and the Cr component using the extended area offset values set by the setting unit.

(6) The image processing device according to any one of (3) to (5), wherein the setting unit sets the extended area offset value according to a variance value of the pixel values of the luminance component and the chrominance component in respective predetermined areas within the image.

(7) The image processing device according to (6), wherein the setting unit sets the extended area offset value based on an average value of the variance values of the pixel values of the chrominance component on the entire screen with respect to an area in which the variance value of the pixel values of the luminance component in the respective areas is equal to or smaller than a predetermined threshold value.

(8) The image processing device according to any one of (2) to (7), further including an output unit that outputs the extended area offset value.

(9) The image processing device according to (8), wherein the output unit inhibits outputting of the extended area offset value that is greater than the normal area offset value.

(10) The image processing device according to any one of (2) to (9), wherein the extended area offset value is applied to the quantization process for an area having a size larger than 16×16 pixels, and the normal area offset value is applied to the quantization process for an area having a size equal to or smaller than 16×16 pixels.

(11) An image processing method of an image processing device, including: allowing a correction unit to correct the relation between a quantization parameter for a luminance component of image data and a quantization parameter for a chrominance component of the image data using an extended area offset value which is an offset value to be applied to a quantization process for an area that is larger than a predetermined size within an image of the image data; allowing a quantization parameter generating unit to generate the quantization parameter for the chrominance component of the area that is larger than the predetermined size from the quantization parameter for the luminance component based on the corrected relation; and allowing a quantization unit to quantize the data of the area using the quantization parameter generated.

(12) An image processing device including: a correction unit that corrects the relation between a quantization parameter for a luminance component of image data and a quantization parameter for a chrominance component of the image data using an extended area offset value which is an offset value to be applied to a quantization process of an area that is larger than a predetermined size within an image of the image data; a quantization parameter generating unit that generates the quantization parameter for the chrominance component of the area that is larger than the predetermined size from the quantization parameter for the luminance component based on the relation corrected by the correction unit; and a dequantization unit that dequantizes the data of the area using the quantization parameter generated by the quantization parameter generating unit.

(13) An image processing method of an image processing device, including: allowing a correction unit to correct the relation between a quantization parameter for a luminance component of image data and a quantization parameter for a chrominance component of the image data using an extended area offset value which is an offset value to be applied to a quantization process of an area that is larger than a predetermined size within an image of the image data; allowing a quantization parameter generating unit to generate the quantization parameter for the chrominance component of the area that is larger than the predetermined size from the quantization parameter for the luminance component based on the corrected relation; and allowing a dequantization unit to dequantize the data of the area using the generated quantization parameter.

### REFERENCE SIGNS LIST

100 Image encoding device
105 Quantization unit
108 Dequantization unit
121 Extended macroblock chrominance quantization unit
121 Extended macroblock chrominance dequantization unit
151 Orthogonal transform coefficient buffer
152 Offset calculating unit
153 Quantization parameter buffer
154 Luminance and chrominance determination unit
155 Luminance quantization unit
156 Block size determining unit
157 Chrominance quantization unit
158 Quantized orthogonal transform coefficient buffer
200 Image decoding device
203 Dequantization unit
221 Extended macroblock chrominance dequantization unit
251 Quantization parameter buffer
252 Luminance and chrominance determination unit
253 Luminance dequantization unit
254 Block size determining unit
255 Chrominance dequantization unit
256 Orthogonal transform coefficient buffer

1-13. (canceled)

14. An image processing device comprising:
a setting unit that sets a chrominance quantization parameter used when quantizing a chrominance component of a second block which has a block size greater than a block size of a first block, which is the unit of encoding an image, using an offset of the chrominance quantization parameter used when quantizing the chrominance component of the second block of the image and a luminance quantization parameter used when quantizing a luminance component of the second block of the image; and
a quantization unit that quantizes the chrominance component of the second block of the image using the chrominance quantization parameter set by the setting unit.

15. The image processing device according to claim 14, wherein
the setting unit sets the chrominance quantization parameter used when quantizing the chrominance component of the second block using a correspondence between a luminance quantization parameter used when quantizing a luminance component of the first block and a chrominance quantization parameter used when quantizing a chrominance component of the first block.

16. The image processing device according to claim 15, wherein
the setting unit sets the chrominance quantization parameter used when quantizing the chrominance component of the second block by correcting, using the offset, a correspondence between a luminance quantization parameter used when quantizing a luminance component of the first block and a chrominance quantization parameter used when quantizing a chrominance component of the first block.

17. The image processing device according to claim 14, further comprising:
an offset setting unit that sets the offset of the chrominance quantization parameter used when quantizing the chrominance component of the second block of the image.

18. The image processing device according to claim 14, further comprising:
an encoding unit that encodes quantized data generated by the quantization unit to generate a bit stream; and
a transmission unit that transmits the offset of the chrominance quantization parameter used when quantizing the chrominance component of the second block of the image as a parameter of the bit stream generated by the encoding unit.

19. The image processing device according to claim 14, wherein
the setting unit sets a chrominance quantization parameter used when quantizing the chrominance component of the first block using the offset of the chrominance quantization parameter used when quantizing the chrominance component of the first block of the image and the luminance quantization parameter used when quantizing the luminance component of the first block of the image.

20. The image processing device according to claim 19, wherein
the setting unit sets the chrominance quantization parameter used when quantizing the chrominance component of the first block using a correspondence between the luminance quantization parameter used when quantizing the luminance component of the first block and the chrominance quantization parameter used when quantizing the chrominance component of the first block.

21. The image processing device according to claim 19, further comprising:
an offset setting unit that sets the offset of the chrominance quantization parameter used when quantizing the chrominance component of the first block of the image.

22. The image processing device according to claim 19, further comprising:
an encoding unit that encodes quantized data generated by the quantization unit to generate a bit stream; and
a transmission unit that transmits the offset of the chrominance quantization parameter used when quantizing the chrominance component of the first block of the image as a parameter of the bit stream generated by the encoding unit.

23. An image processing method of an image processing device, comprising:
setting a chrominance quantization parameter used when quantizing a chrominance component of a second block which has a block size greater than a block size of a first block, which is the unit of encoding an image, using an offset of the chrominance quantization parameter used when quantizing the chrominance component of the second block of the image and a luminance quantization parameter used when quantizing a luminance component of the second block of the image; and
quantizing the chrominance component of the second block of the image using the set chrominance quantization parameter.

24. An image processing device comprising:
a setting unit that sets a chrominance quantization parameter used when dequantizing a chrominance component of data of a second block which has a block size greater than a block size of a first block, which is the unit of decoding a bit stream, using an offset of the chrominance quantization parameter used when dequantizing the chrominance component of the data of the second block of the image and a luminance quantization parameter used when dequantizing a luminance component of the data of the second block; and
a dequantization unit that dequantizes the chrominance component of the data of the second block using the chrominance quantization parameter set by the setting unit.

25. The image processing device according to claim 24, wherein
the setting unit sets the chrominance quantization parameter used when dequantizing the chrominance component of the data of the second block using a correspondence between a luminance quantization parameter used when dequantizing a luminance component of the data of the first block and a chrominance quantization parameter used when dequantizing a chrominance component of the data of the first block.

26. The image processing device according to claim 25, wherein
the setting unit sets the chrominance quantization parameter used when dequantizing the chrominance component of the data of the second block by correcting, using the offset, the correspondence between a luminance quantization parameter used when dequantizing a luminance component of the data of the first block and a chrominance quantization parameter used when dequantizing a chrominance component of the data of the first block.

27. The image processing device according to claim 24, further comprising:
an offset setting unit that sets the offset of the chrominance quantization parameter used when dequantizing the chrominance component of the data of the second block.

28. The image processing device according to claim 24, further comprising:
a receiving unit that receives the offset of the chrominance quantization parameter used when dequantizing the chrominance component of the data of the second block as a parameter of the bit stream; and
a decoding unit that decodes the bit stream to generate quantized data, wherein
the setting unit sets the chrominance quantization parameter used when dequantizing the chrominance component of the data of the second block using the offset received by the receiving unit and the luminance quantization parameter used when dequantizing the luminance component of the data of the second block.

29. The image processing device according to claim 24, wherein
the setting unit sets a chrominance quantization parameter used when dequantizing the chrominance component of the data of the first block using the offset of the chrominance quantization parameter used when dequantizing the chrominance component of the data of the first block and the luminance quantization parameter used when dequantizing the luminance component of the data of the first block.

30. The image processing device according to claim 29, wherein
the setting unit sets the chrominance quantization parameter used when dequantizing the chrominance component of the data of the first block using a correspondence between the luminance quantization parameter used when dequantizing the luminance component of the data of the first block and the chrominance quantization parameter used when dequantizing the chrominance component of the data of the first block.

31. The image processing device according to claim 29, further comprising:
a receiving unit that receives the offset of the chrominance quantization parameter used when dequantizing the chrominance component of the data of the first block as a parameter of the bit stream.

32. The image processing device according to claim 31, further comprising:
a decoding unit that decodes the bit stream to generate quantized data, wherein
the setting unit sets the chrominance quantization parameter used when dequantizing the chrominance component of the data of the first block using the offset received by the receiving unit and the luminance quantization parameter used when dequantizing the luminance component of the data of the first block.

33. An image processing method of an image processing device, comprising:
setting a chrominance quantization parameter used when dequantizing a chrominance component of data of a second block which has a block size greater than a block size of a first block, which is the unit of decoding a bit stream, using an offset of the chrominance quantization parameter used when dequantizing the chrominance component of the data of the second block of the image and a luminance quantization parameter used when dequantizing a luminance component of the data of the second block; and
dequantizing the chrominance component of the data of the second block using the chrominance quantization parameter set by the setting unit.
